(19) United States
(12) Patent Application Publication
(10) Pub. No.: US 2025/0208911 A1
(43) Pub. Date: Jun. 26, 2025

(54) INTERFERENCE DETECTION-BASED SCHEDULING FOR SHARING GPUs

(71) Applicant: Futurewei Technologies, Inc., Addison, TX (US)

(72) Inventors: Yaohui Ding, Wellesley, MA (US); Zhaobo Zhang, Redwood City, CA (US); Hao Xu, Redmon, WA (US); Ying Xiong, Bothell, WA (US)

(73) Assignee: Futurewei Technologies, Inc., Addison, TX (US)

(21) Appl. No.: 19/073,621

(22) Filed: Mar. 7, 2025

Related U.S. Application Data
(63) Continuation of application No. PCT/US2022/076029, filed on Sep. 7, 2022.

(51) Int. Cl. G06F 9/50

(52) U.S. Cl. CPC G06F 9/5011

(57) ABSTRACT

A computer-implemented method for artificial intelligence (AI)-based scheduling of workloads includes initiating execution of a first workload on a graphics processing unit (GPU) of a plurality of GPUs. Utilization metrics of the first workload are determined. The utilization metrics are associated with the execution of the first workload on the GPU. A useful feature set of the utilization metrics of the first workload is extracted using a transformation function of a deep learning (DL) model. The useful feature set includes a subset of the utilization metrics. A workload type of the first workload is determined using the useful feature set. A shared execution of the first workload and a second workload on a second GPU of the plurality of GPUs is configured based on packing the first workload with the second workload. The second workload is associated with the workload type of the first workload.

### CROSS-REFERENCE TO RELATED APPLICATIONS

This application is a continuation of International Application No. PCT/US2022/076029, filed Sep. 7, 2022, which application is incorporated herein by reference in its entirety.

### TECHNICAL FIELD

The present disclosure is related to sharing of computing resources in a cloud-native environment, such as artificial intelligence (AI)-based scheduling for sharing graphics processing unit (GPU) resources.

### BACKGROUND

GPUs have strong parallel processing capabilities because they integrate thousands of computing cores on a chip. Therefore, GPUs can provide extensive computing power to drive deep-learning (DL) tasks such as Computer Vision (CV), Natural Language Processing (NLP), and High-Performance Computing (HPC). As the DL field has grown at a fast pace in the past few years, different techniques are emerging for accessing and configuring GPU resources. However, existing techniques are associated with low GPU resource utilization as well as limited GPU resource sharing capabilities.

### SUMMARY

Various examples are now described to introduce a selection of concepts in a simplified form that is further described below in the detailed description. The Summary is not intended to identify key or essential features of the claimed subject matter, nor is it intended to be used to limit the scope of the claimed subject matter.

According to a first aspect of the present disclosure, there is provided a computer-implemented method for artificial intelligence (AI)-based scheduling of workloads. The method includes initiating execution of a first workload on a graphics processing unit (GPU) of a plurality of GPUs; determining utilization metrics of the first workload, the utilization metrics associated with the execution of the first workload on the GPU; extracting a useful feature set of the utilization metrics of the first workload using a transformation function of a deep learning (DL) model, the useful feature set including a subset of the utilization metrics; determining a workload type of the first workload using the useful feature set; and configuring a shared execution of the first workload and a second workload on a second GPU of the plurality of GPUs based on packing the first workload with the second workload, the second workload associated with the workload type of the first workload.

In a first implementation form of the method according to the first aspect as such, the DL model includes an AI-based encoder and an AI-based decoder. The method further includes performing training of the DL model using a first set of training data as an input to the AI-based encoder and a second set of training data as an output of the AI-based decoder.

In a second implementation form of the method according to the first aspect as such or any preceding implementation form of the first aspect, the first set of training data is configured to include prior utilization metrics for a plurality of workloads executed before the execution of the first workload. The plurality of workloads includes the second workload.

In a third implementation form of the method according to the first aspect as such or any preceding implementation form of the first aspect, the second set of training data is configured as a plurality of joint completion times associated with a corresponding plurality of joint executions associated with the plurality of workloads.

In a fourth implementation form of the method according to the first aspect as such or any preceding implementation form of the first aspect, a joint execution of the plurality of joint executions includes at least two of the plurality of workloads executing on a same GPU of the plurality of GPUs.

In a fifth implementation form of the method according to the first aspect as such or any preceding implementation form of the first aspect, the transformation function is determined using a subset of convolution layers of a plurality of convolution layers on an AI-based encoder of the DL model.

In a sixth implementation form of the method according to the first aspect as such or any preceding implementation form of the first aspect, the transformation function is applied to utilization metrics of a plurality of workloads to obtain additional useful feature sets. The plurality of workloads are executed before the execution of the first workload, and the plurality of workloads include the second workload.

In a seventh implementation form of the method according to the first aspect as such or any preceding implementation form of the first aspect, the workload type of the first workload is determined using a comparison of the useful feature set with each of the additional useful feature sets. The second workload is selected based on the comparison.

In an eighth implementation form of the method according to the first aspect as such or any preceding implementation form of the first aspect, the selecting of the second workload includes selecting the second workload when the useful feature set is different from an additional useful feature set of the additional useful feature sets by at most a threshold value. The additional useful feature set is associated with the second workload.

In a ninth implementation form of the method according to the first aspect as such or any preceding implementation form of the first aspect, the configuring of the shared execution of the first workload and the second workload is performed when the useful feature set is different from the additional useful feature set by not more than the threshold value.

In a tenth implementation form of the method according to the first aspect as such or any preceding implementation form of the first aspect, a plurality of virtual GPUs (vGPUs) of the second GPU are configured. The configuring of the shared execution of the first workload and the second workload uses the plurality of vGPUs of the second GPU.

In an eleventh implementation form of the method according to the first aspect as such or any preceding implementation form of the first aspect, the utilization metrics include at least one of a histogram of GPU usage by one or more containers associated with the execution of the first workload, a histogram of memory usage of a computing node associated with the execution of the first workload, and a GPU type associated with the GPU used for the execution of the first workload.

According to a second aspect of the present disclosure, there is provided a system for artificial intelligence (AI)-based scheduling of workloads, the system including a memory that stores instructions and at least one processor in communication with the memory. The at least one processor is configured, upon execution of the instructions, to perform operations including: initiating execution of a first workload on a graphics processing unit (GPU) of a plurality of GPUs; determining utilization metrics of the first workload, the utilization metrics associated with the execution of the first workload on the GPU; extracting a useful feature set of the utilization metrics of the first workload using a transformation function of a deep learning (DL) model, the useful feature set including a subset of the utilization metrics; determining a workload type of the first workload using the useful feature set; and configuring a shared execution of the first workload and a second workload on a second GPU of the plurality of GPUs based on packing the first workload with the second workload, the second workload associated with the workload type of the first workload.

In a first implementation form of the system according to the second aspect as such, the DL model includes an AI-based encoder and an AI-based decoder. The method further includes performing training of the DL model using a first set of training data as an input to the AI-based encoder and a second set of training data as an output of the AI-based decoder.

In a second implementation form of the system according to the second aspect as such or any preceding implementation form of the second aspect, the first set of training data is configured to include prior utilization metrics for a plurality of workloads executed before the execution of the first workload. The plurality of workloads includes the second workload.

In a third implementation form of the system according to the second aspect as such or any preceding implementation form of the second aspect, the second set of training data is configured as a plurality of joint completion times associated with a corresponding plurality of joint executions associated with the plurality of workloads.

In a fourth implementation form of the system according to the second aspect as such or any preceding implementation form of the second aspect, a joint execution of the plurality of joint executions includes at least two of the plurality of workloads executing on a same GPU of the plurality of GPUs.

In a fifth implementation form of the system according to the second aspect as such or any preceding implementation form of the second aspect, the transformation function is determined using a subset of convolution layers of a plurality of convolution layers on an AI-based encoder of the DL model.

In a sixth implementation form of the system according to the second aspect as such or any preceding implementation form of the second aspect, the transformation function is applied to utilization metrics of a plurality of workloads to obtain additional useful feature sets. The plurality of workloads are executed before the execution of the first workload, and the plurality of workloads include the second workload.

In a seventh implementation form of the system according to the second aspect as such or any preceding implementation form of the second aspect, the workload type of the first workload is determined using a comparison of the useful feature set with each of the additional useful feature sets. The second workload is selected based on the comparison.

In an eighth implementation form of the system according to the second aspect as such or any preceding implementation form of the second aspect, the selecting of the second workload includes selecting the second workload when the useful feature set is different from an additional useful feature set of the additional useful feature sets by at most a threshold value. The additional useful feature set is associated with the second workload.

In a ninth implementation form of the system according to the second aspect as such or any preceding implementation form of the second aspect, the configuring of the shared execution of the first workload and the second workload is performed when the useful feature set is different from the additional useful feature set by not more than the threshold value.

In a tenth implementation form of the system according to the second aspect as such or any preceding implementation form of the second aspect, a plurality of virtual GPUs (vGPUs) of the second GPU are configured. The configuring of the shared execution of the first workload and the second workload uses the plurality of vGPUs of the second GPU.

In an eleventh implementation form of the system according to the second aspect as such or any preceding implementation form of the second aspect, the utilization metrics include at least one of a histogram of GPU usage by one or more containers associated with the execution of the first workload, a histogram of memory usage of a computing node associated with the execution of the first workload, and a GPU type associated with the GPU used for the execution of the first workload.

According to a third aspect of the present disclosure, there is provided a non-transitory computer-readable medium storing instruction for artificial intelligence (AI)-based scheduling of workloads, that when executed by one or more processors, cause the one or more processors to perform operations. The operations include: initiating execution of a first workload on a graphics processing unit (GPU) of a plurality of GPUs; determining utilization metrics of the first workload, the utilization metrics associated with the execution of the first workload on the GPU; extracting a useful feature set of the utilization metrics of the first workload using a transformation function of a deep learning (DL) model, the useful feature set including a subset of the utilization metrics; determining a workload type of the first workload using the useful feature set; and configuring a shared execution of the first workload and a second workload on a second GPU of the plurality of GPUs based on packing the first workload with the second workload, the second workload associated with the workload type of the first workload.

In a first implementation form of the non-transitory computer-readable medium according to the third aspect as such, the DL model includes an AI-based encoder and an AI-based decoder. The method further includes performing training of the DL model using a first set of training data as an input to the AI-based encoder and a second set of training data as an output of the AI-based decoder.

In a second implementation form of the non-transitory computer-readable medium according to the third aspect as such or any preceding implementation form of the third aspect, the first set of training data is configured to include prior utilization metrics for a plurality of workloads executed before the execution of the first workload. The plurality of workloads includes the second workload.

In a third implementation form of the non-transitory computer-readable medium according to the third aspect as such or any preceding implementation form of the third aspect, the second set of training data is configured as a plurality of joint completion times associated with a corresponding plurality of joint executions associated with the plurality of workloads.

In a fourth implementation form of the non-transitory computer-readable medium according to the third aspect as such or any preceding implementation form of the third aspect, a joint execution of the plurality of joint executions includes at least two of the plurality of workloads executing on a same GPU of the plurality of GPUs.

In a fifth implementation form of the non-transitory computer-readable medium according to the third aspect as such or any preceding implementation form of the third aspect, the transformation function is determined using a subset of convolution layers of a plurality of convolution layers on an AI-based encoder of the DL model.

In a sixth implementation form of the non-transitory computer-readable medium according to the third aspect as such or any preceding implementation form of the third aspect, the transformation function is applied to utilization metrics of a plurality of workloads to obtain additional useful feature sets. The plurality of workloads are executed before the execution of the first workload, and the plurality of workloads include the second workload.

In a seventh implementation form of the non-transitory computer-readable medium according to the third aspect as such or any preceding implementation form of the third aspect, the workload type of the first workload is determined using a comparison of the useful feature set with each of the additional useful feature sets. The second workload is selected based on the comparison.

In an eighth implementation form of the non-transitory computer-readable medium according to the third aspect as such or any preceding implementation form of the third aspect, the selecting of the second workload includes selecting the second workload when the useful feature set is different from an additional useful feature set of the additional useful feature sets by at most a threshold value. The additional useful feature set is associated with the second workload.

In a ninth implementation form of the non-transitory computer-readable medium according to the third aspect as such or any preceding implementation form of the third aspect, the configuring of the shared execution of the first workload and the second workload is performed when the useful feature set is different from the additional useful feature set by not more than the threshold value.

In a tenth implementation form of the non-transitory computer-readable medium according to the third aspect as such or any preceding implementation form of the third aspect, a plurality of virtual GPUs (vGPUs) of the second GPU are configured. The configuring of the shared execution of the first workload and the second workload uses the plurality of vGPUs of the second GPU.

In an eleventh implementation form of the non-transitory computer-readable medium according to the third aspect as such or any preceding implementation form of the third aspect, the utilization metrics include at least one of a histogram of GPU usage by one or more containers associated with the execution of the first workload, a histogram of memory usage of a computing node associated with the execution of the first workload, and a GPU type associated with the GPU used for the execution of the first workload.

According to a fourth aspect of the present disclosure, there is provided a system for artificial intelligence (AI)-based scheduling of workloads. The system includes: means for initiating execution of a first workload on a graphics processing unit (GPU) of a plurality of GPUs; means for determining utilization metrics of the first workload, the utilization metrics associated with the execution of the first workload on the GPU; means for extracting a useful feature set of the utilization metrics of the first workload using a transformation function of a deep learning (DL) model, the useful feature set including a subset of the utilization metrics; means for determining a workload type of the first workload using the useful feature set; and means for configuring a shared execution of the first workload and a second workload on a second GPU of the plurality of GPUs based on packing the first workload with the second workload, the second workload associated with the workload type of the first workload.

Anyone of the foregoing examples may be combined with any one or more of the other foregoing examples to create a new embodiment within the scope of the present disclosure.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is a high-level system overview of a network architecture with a workload management module performing workload management functionalities, according to some example embodiments.

FIG. 2 is a block diagram of computing nodes implementing the workload management module of FIG. 1, according to some example embodiments.

FIG. 3 is a diagram illustrating workload (or job) packing and corresponding joint completion times for completing the workloads, according to some example embodiments.

FIG. 4 is a diagram illustrating example utilization metrics collected and used by the workload management module of FIG. 1, according to some example embodiments.

FIG. 5 is a diagram illustrating example workloads that can be managed by the workload management module of FIG. 1, according to some example embodiments.

FIG. 6 is a block diagram illustrating an example device plugin architecture used in connection with workload management, according to some example embodiments.

FIG. 7 is a block diagram illustrating an example profiler architecture used in connection with workload management, according to some example embodiments.

FIG. 8 is a block diagram of an example workflow for scheduling workloads, according to some example embodiments.

FIG. 9 is a diagram with an example pseudo-code associated with the workflow of FIG. 8, according to some example embodiments.

FIG. 10 is a diagram of an example trained DL model used in connection with workload management, according to some example embodiments.

FIG. 11 is a diagram of an encoder network and a decoder network of the DL model of FIG. 10, according to some example embodiments.

FIG. 12 and FIG. 13 are diagrams of training the DL model of FIG. 10, according to some example embodiments.

FIG. 14 and FIG. 15 are diagrams illustrating the generation of a transformation function for workload scheduling using the encoder network of the DL model of FIG. 10, according to some example embodiments.

FIG. 16 is a block diagram illustrating the training of a deep learning (DL) program using a DL training architecture (DLTA), according to some example embodiments.

FIG. 17 is a diagram illustrating the generation of a trained DL program using a neural network model trained within a DLTA, according to some example embodiments.

FIG. 18 is a flowchart of a method suitable for workload scheduling, according to some example embodiments.

FIG. 19 is a block diagram illustrating a representative software architecture, which may be used in conjunction with various device hardware described herein, according to some example embodiments.

FIG. 20 is a block diagram illustrating circuitry for a device that implements algorithms and performs methods, according to some example embodiments.

### DETAILED DESCRIPTION

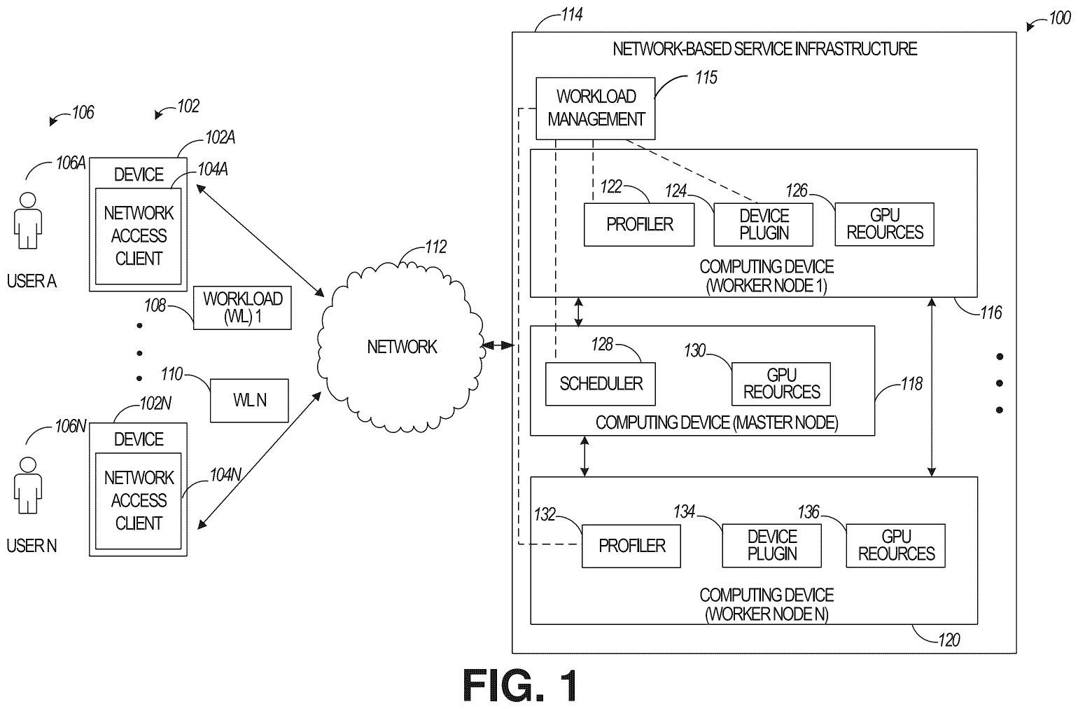

It should be understood at the outset that although an illustrative implementation of one or more embodiments is provided below, the disclosed systems and/or methods described with respect to FIGS. 1-20 may be implemented using any number of techniques, whether currently known or not yet in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In the following description, reference is made to the accompanying drawings that form a part hereof, and in which are shown, by way of illustration, specific embodiments which may be practiced. These embodiments are described in sufficient detail to enable those skilled in the art to practice the inventive subject matter, and it is to be understood that other embodiments may be utilized, and that structural, logical, and electrical changes may be made without departing from the scope of the present disclosure. The following description of example embodiments is, therefore, not to be taken in a limiting sense, and the scope of the present disclosure is defined by the appended claims.

As used herein, the term “network-based service infrastructure” includes a plurality of network devices (also referred to as hosts, nodes, or servers) providing on-demand computing capacity (e.g., via one or more virtual machines or other virtual resources running on the network devices) and storage capacity as a service to a community of end-recipients (e.g., customers of the service infrastructure), where the end recipients are communicatively coupled to the network devices within the service infrastructure via a network. The customers of the service infrastructure can use one or more computing devices (or customer devices) to access and manage the services (e.g., workload scheduling services) provided by the service infrastructure via the network. The customer devices, the network, and the network-based service infrastructure can be collectively referred to as a “network architecture.” The customers of the service infrastructure can also be referred to as “users.”

As used herein, the term “resource usage” is synonymous with “computing resource usage” and indicates the computing resources that are being utilized by a virtual machine or a container within a network-based service infrastructure. A computing resource can include one or more of the following resources of a host: central processing unit (CPU) resources, graphics processing unit (GPU) resources, memory resources, and other host resources. Additionally, computing resource usage can be monitored and can change dynamically, or it can be adjusted dynamically.

As used herein, the term “virtual machine” (or VM) is used interchangeably with the term “container” in connection with executing function code associated with a service provided by a network-based service architecture. More specifically, function code and function runtime can be hosted at (and executed from) a container or a VM instantiated on a host device within the service architecture.

As used herein, the term “worker” (or “worker node”) refers to a worker machine that is part of a deep learning training architecture (DLTA) together with other workers. In some aspects, the worker machines are all coupled to each other (e.g., in a ring topology). Gradients can be exchanged between the worker machines and each worker machine can perform its gradient averaging and gradient updates (e.g., gradient synchronization). As used herein, the terms “worker” and “worker machine” are interchangeable.

As used herein, the terms “forward computation” and “backward computation” refer to computations performed in connection with the training of a neural network model (or another type of model). The computations performed in a current iteration during forward and backward computations modify weights based on results from prior iterations (e.g., based on gradients generated at a conclusion of a prior backward computation).

As used herein, the term “packing workloads” (or “packing”) indicates executing workloads while sharing GPU resources. For example, packing workloads A and B indicates executing workload A using a first set of virtual GPU (vGPU) resources of a physical GPU, and after workload A completes execution, executing workload B using a second (remaining) set of virtual resources of the physical GPU.

Scheduling workloads in a distributed computing cluster can be resource-intensive and can rely on sophisticated processing algorithms. For example, a Kubernetes (K8S) platform can be used for running and orchestrating containerized workloads (e.g., which can be considered as an example of clusters). The Kubernetes platform can include worker machines (or nodes) that run containerized applications. In some aspects, scheduling in a Kubernetes platform refers to monitoring a group of containerized workloads (e.g., pods), analyzing their resource (e.g., CPU, memory, network) requests, and determining an optimal node for a pod to place and run on in connection with a certain high-level objective such as the shortest job completion time, the highest resource utilization rate, etc.

Graphics processing units (GPUs) have strong parallel processing capabilities because they integrate thousands of computing cores on a chip. In this regard, GPUs can provide extensive computing power to drive different DL tasks. In some aspects, a device plugin mechanism can be configured in a Kubernetes platform to allow GPU-related workloads to access physical GPU cards installed in nodes as an extended hardware resource. Although the GPUs can be accessible and manageable by the K8S cluster via the device plugins, most cluster administrations still experience drawbacks including low GPU resource utilization.

Underutilization of GPU resources in a K8S platform can be the result of enforcement of exclusive GPU usage that prevents sharing GPUs across pods. In other words, the default scheduling in K8S only supports the addition and subtraction of integer GPU granularity rather than any fraction of a single GPU. Using integer GPU granularity can be a suitable design for AI-based (e.g., DL) jobs because the GPU usage of each DL application cannot be affected by other applications. However, such processing can lead to significant resource underutilization, especially for model development and inference scenarios where the utilization rate of a single GPU is low. In this regard, allowing more services to share a single physical GPU card can significantly increase resource utilization in a cluster.

Moreover, even though a physical GPU can be virtualized into fractional virtualized GPUs (also referred to as vGPUs) and isolate the vGPUs among pods, there are only native strategies available for scheduling these fractional GPUs, such as a simple bin-pack or spread method. In the bin-pack scheduling strategy, the workloads are placed on nodes to leave the least amount of unused vGPU resources and help to optimize resource utilization. The spread scheduling strategy places the workloads evenly across the cluster to help maximize availability. However, both options ignore workload characteristics and do not consider any potential interference between workloads being packed into a single physical GPU.

Table 1 below illustrates the interference when two jobs are packed together. As seen in Table 1, when job (or workload) A and job B share a single physical GPU, their joint completion times (or JCTs) increase compared to when they use the GPU exclusively. Even though the prolonged JCTs are expected to some extent, it can be noticed from Table 1 that the interference is workload-specific. For example, job C may less affect Job A than Job B because of its certain characteristics. In other words, there is a “best partner” for Job A to pack with regarding their job completion time.

TABLE 1

| | A physical GPU | | | |
|---|---|---|---|---|
| | that is virtualized | | JCT | |
| | as 2 halves | | (sec) | |
| Only Job A | Job A | | 570 | |
| Only Job B | | Job B | 2,795 | |
| Packing Job A | Job A | Job B | Job A | 630 |
| With Job B | | | Job B | 3,115 |

The disclosed workload scheduling techniques can be used to expose a single physical GPU as sharable by containers executing workloads. By using the disclosed scheduling techniques, GPU-related workloads can be scheduled more efficiently by monitoring the actual utilization of resources and reducing interference between the workloads sharing the GPU. The disclosed workload scheduling techniques can also be used to find each workload's “best partner” (also referred to as optimal partner or optimal workload partner) to share the GPU based on interference detection and interference avoidance.

In some aspects, the disclosed techniques can use a deep learning-based model to detect workload interference without any manual feature engineering. To train the deep learning-based model, a profiler module is designed to collect utilization metrics from different types of AI workloads. Furthermore, the disclosed techniques use a scheduling pipeline to implement a scheduling algorithm with an online-learning pattern. In some aspects, the online-learning pattern can be used to process different types of AI workloads.

In comparison to existing solutions using single-level scheduling (e.g., scheduling based on a cloud service orchestration scheme creating warm containers where each container is using/reserving actual host resources), the disclosed techniques use a workload management module configured with a scheduling algorithm based on interference detection under the GPU sharing scenario. Conventional scheduling techniques only use integral GPU scheduling or retain simple scheduling strategies without considering any interference when GPUs are shared by jobs. Additionally, the disclosed scheduling techniques can be trained upon utilization metrics that are defined and collected by a profiler module (which can be part of the workload management module). In some aspects, the disclosed scheduling algorithm is trained using the data collected by the profiler module from at least 1,000 simulated workloads.

The workload management module further includes a device plugin and a scheduler module. The device plugin can be used to virtualize GPU resources into a plurality of vGPUs. The scheduler module can be configured with a scheduling pipeline performing the following functionalities: (a) perform a dry-run procedure for the new workload to collect metrics using the profiler module; (b) determine the category for the new workload using a DL model; (c) allocate the new workload to its optimal workload partner; and (d) perform incremental DL model training and configuration. An additional description of the workload management module, including the device plugin, the profiler module, and the scheduler module, is provided below in connection with FIGS. 1-20.

FIG. 1 is a high-level system overview of a network architecture with a workload management module performing workload management functionalities, according to some example embodiments. Referring to FIG. 1, the network architecture 100 can include a plurality of devices (e.g., user devices) 102A, . . . , 102N (collectively, devices 102) communicatively coupled to a network-based service infrastructure 114 via a network 112. The devices 102A, . . . , 102N are associated with corresponding users 106A, . . . , 106N and can be configured to interact with the network-based service infrastructure 114 using a network access client, such as one of network access clients 104A, . . . , 104N. The network access clients 104A, . . . , 104N can be implemented as web clients or application (app) clients.

Users 106A, . . . , 106N may be referred to generically as “a user 106” or collectively as “users 106.” Each user 106 may be a human user (e.g., a human being), a machine user (e.g., a computer configured by a software program to interact with the devices 102 and the network-based service infrastructure 114), or any suitable combination thereof (e.g., a human assisted by a machine or a machine supervised by a human). The users 106 are not part of the network architecture 100 but are each associated with one or more of the devices 102 and may be users of the devices 102 (e.g., the user 106A may be an owner of the device 102A, and the user 106N may be an owner of the device 102N). For example, device 102A may be a desktop computer, a vehicle computer, a tablet computer, a navigational device, a portable media device, or a smartphone belonging to user 106A. Users 106A, . . . , 106N can use devices 102A, . . . , 102N to access services (e.g., workload scheduling services) provided by the workload management module of the network-based service infrastructure 114. In this regard, users 106 can also be referred to as “customers 106” or “tenants 106” of the network-based service infrastructure 114. For example, workload scheduling services can include configuring GPU resources (e.g., virtual GPUs or other computing resources such as memory, CPU resources, etc.) and scheduling one or more of the workloads 108, . . . , 110 provided by any of devices 102 to execute on the configured GPU resources (e.g., packing at least two workloads to execute on the same vGPU) to improve resource utilization and reduce interference among workloads.

The network-based service infrastructure 114 can include a plurality of computing devices 116, 118, . . . , 120, which can also be referred to as nodes. For example, computing device 118 can be configured as a master node, and computing devices 116 and 120 can be configured as worker nodes. In some aspects, computing devices 116, 118, . . . , 120 are configured as part of a Kubernetes infrastructure, where worker nodes (e.g., computing devices 116 and 120 configured as worker nodes) are used to schedule and execute workloads (e.g., workloads 108, . . . , 110 configured via one or more of devices 102 and network 112) using one or more virtual containers. Computing devices 116, 118, and 120 include corresponding GPU resources 126, 130, and 136 which can be used for a shared execution of workloads following the disclosed techniques.

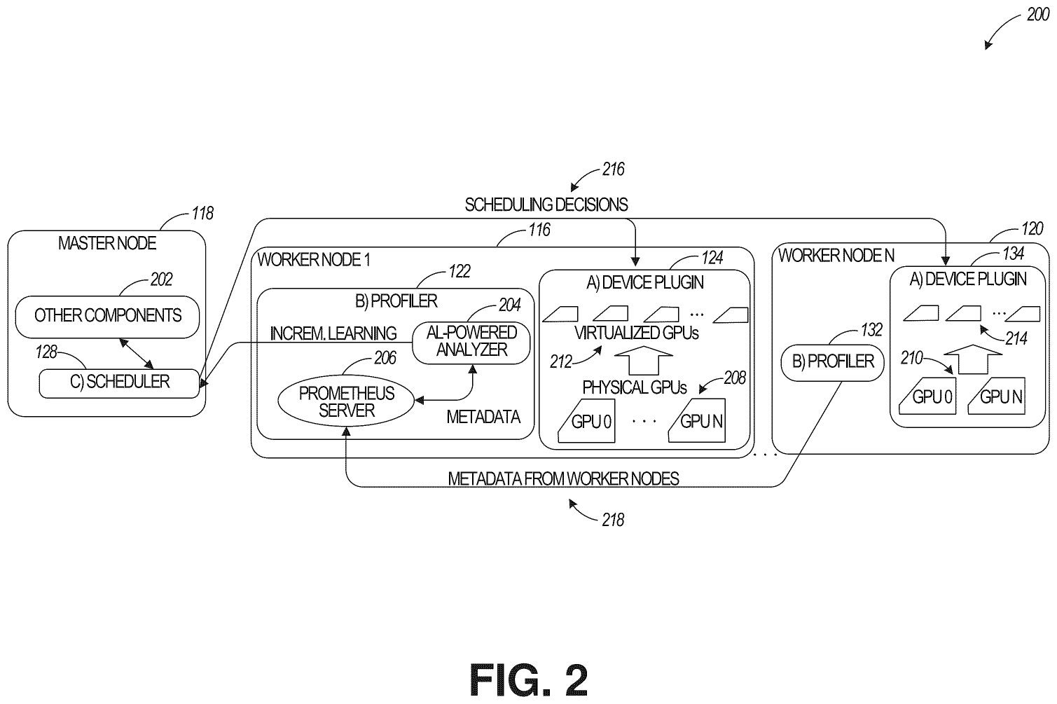

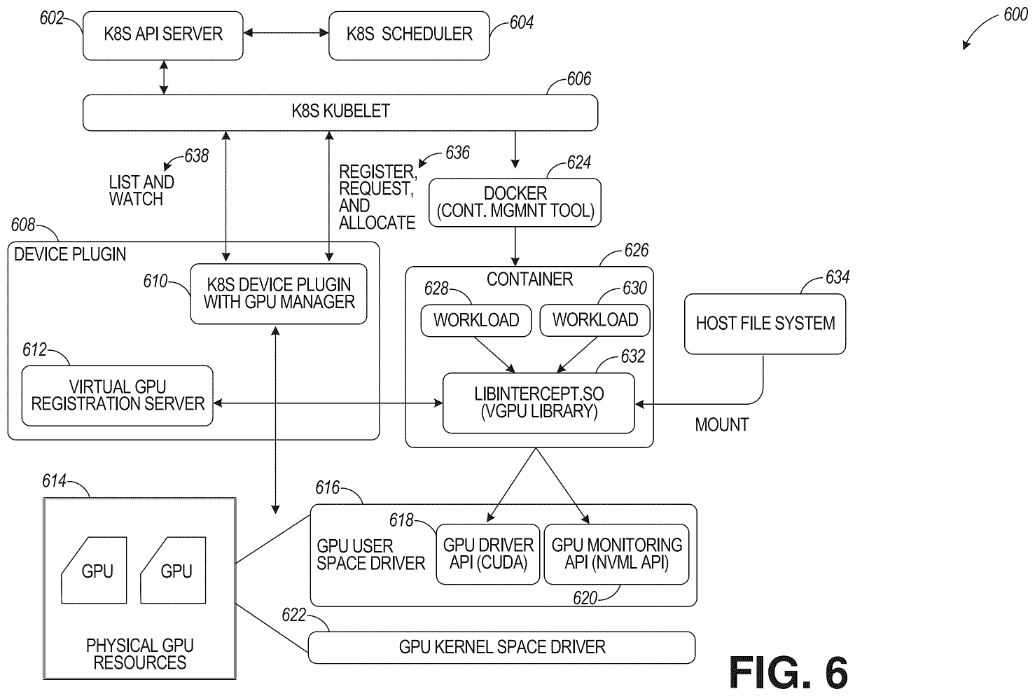

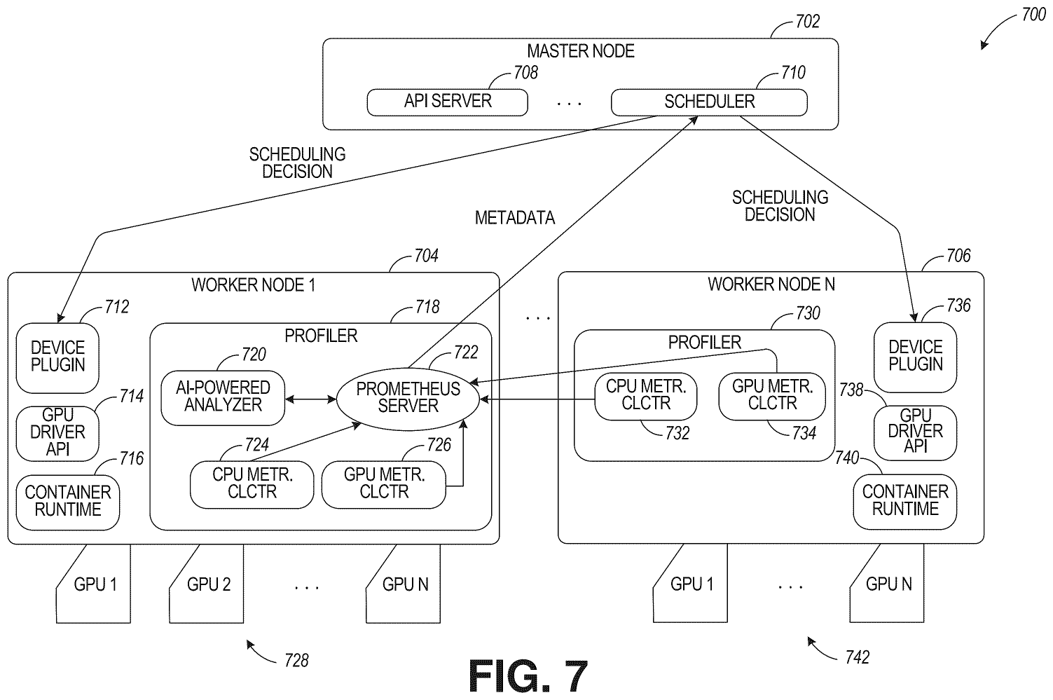

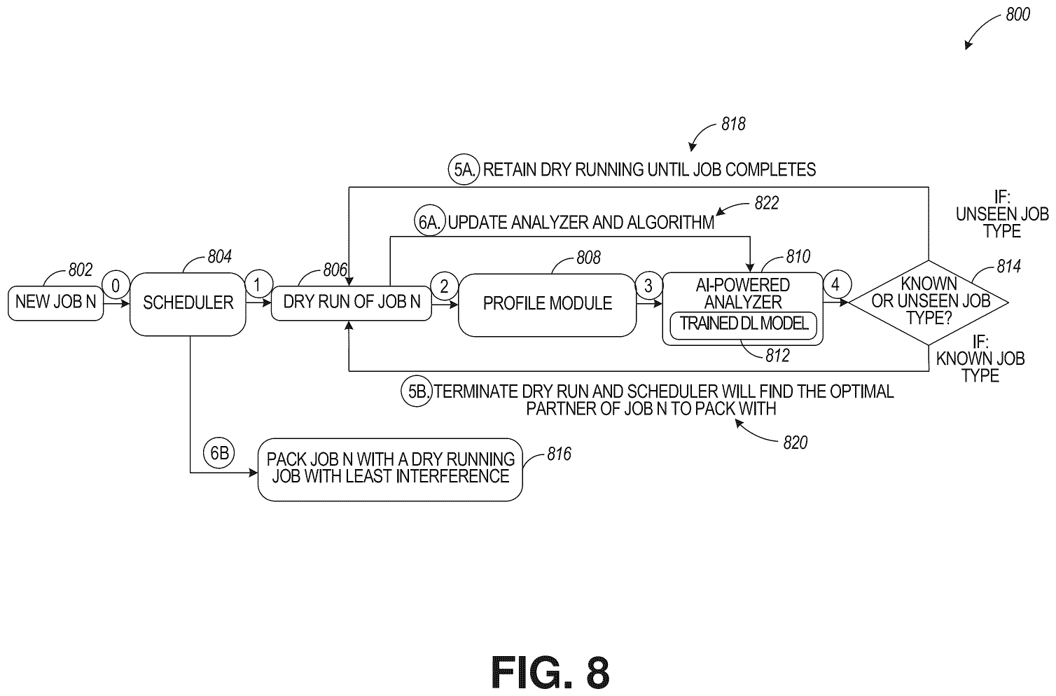

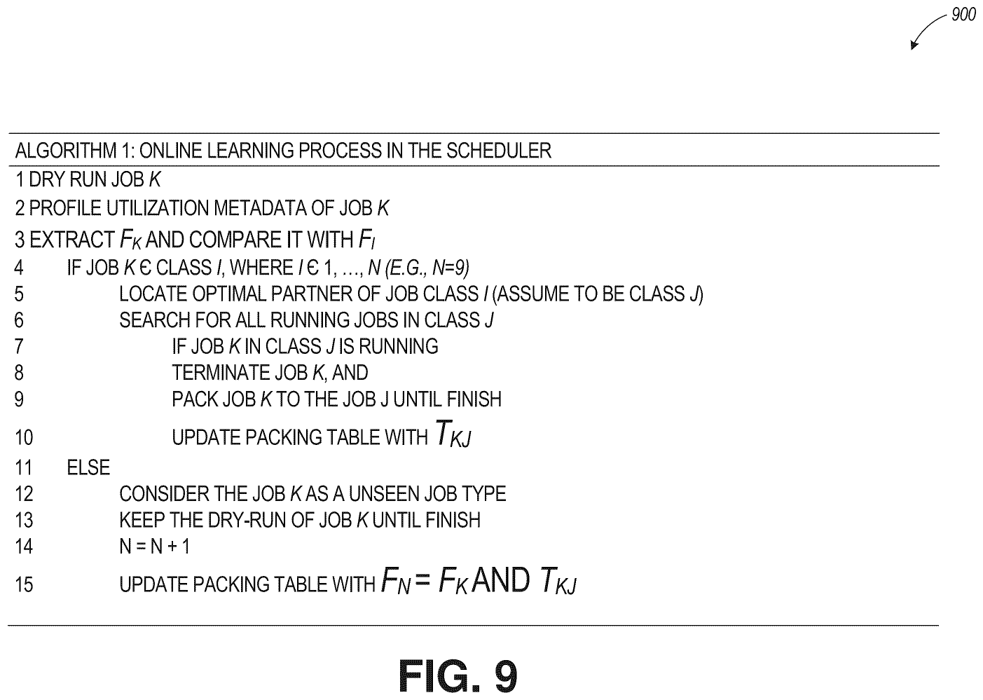

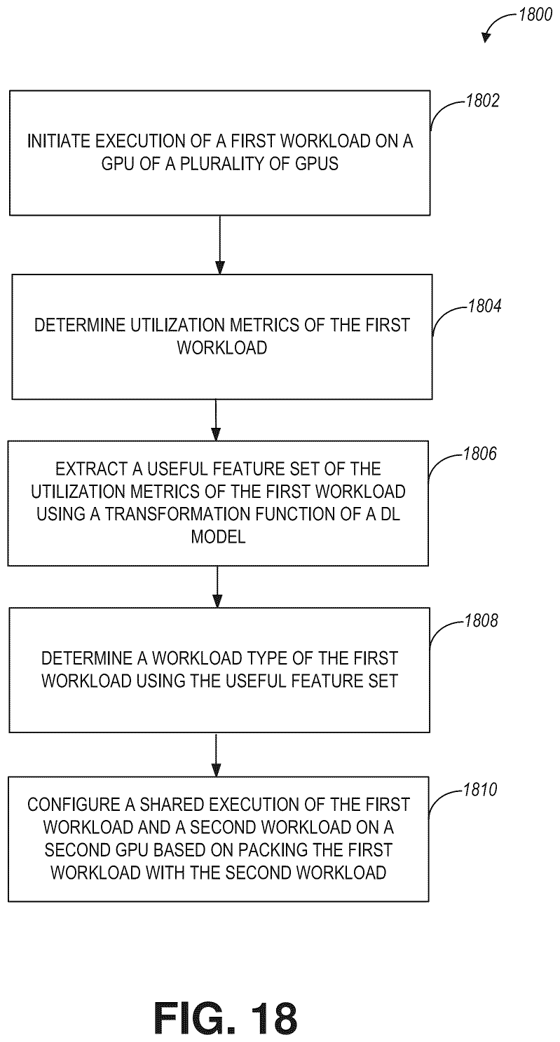

In some embodiments, the network-based service infrastructure 114 includes a workload management module 115 configured to perform the disclosed workload management functionalities. For example, the workload management module 115 can include a scheduler module 128 configured at master node 118, at least one profiler module (e.g., profiler modules 122 and 132 configured at corresponding worker nodes 116 and 120), and at least one device plugin (e.g., device plugins 124 and 134 configured at corresponding worker nodes 116 and 120). Even though FIG. 1 illustrates a particular embodiment where the scheduler module 128, the profiler modules 122 and 132, and the device plugins 124 and 134 are configured at different computing nodes, the disclosure is not limited in this regard and other implementations of the workload management module 115 are also possible (e.g., all components of the workload management module are implemented in a single computing device of the computing devices 116, . . . , 120). A more detailed description of the overall architecture of the workload management module and its components is provided in connection with FIG. 2. A more detailed description of the device plugin is provided in connection with FIG. 6. A more detailed description of the profiler module is provided in connection with FIG. 7. A more detailed description of the overall workflow performed by the components of the workload management module is provided in connection with FIG. 8, FIG. 9, and FIG. 18.

Any of the devices shown in FIG. 1 may be implemented in a general-purpose computer modified (e.g., configured or programmed) by software to be a special-purpose computer to perform the functions described herein for that machine, database, or device. As used herein, a “database” is a data storage resource that stores data structured as a text file, a table, a spreadsheet, a relational database (e.g., an object-relational database, a NoSQL database, a network or graph database), a triple store, a hierarchical data store, or any suitable combination thereof. Additionally, data accessed (or stored) via an application programming interface (API) or remote procedure call (RPC) may be considered to be accessed from (or stored in) a database. Moreover, any two or more of the devices or databases illustrated in FIG. 1 may be combined into a single machine, database, or device, and the functions described herein for any single machine, database, or device may be subdivided among multiple machines, databases, or devices.

Network 112 may be any network that enables the communication between or among machines, databases, and devices (e.g., devices 102A, . . . , 102N and devices 116, 118, . . . , 120 within the network-based service infrastructure 114). Accordingly, network 112 may be a wired network, a wireless network (e.g., a mobile or a cellular network), or any suitable combination thereof. Network 112 may include one or more portions that constitute a private network, a public network (e.g., the Internet), or any suitable combination thereof.

FIG. 2 is a block diagram 200 of computing nodes 116, 118, and 120 implementing the workload management module 115 of FIG. 1, according to some example embodiments. Referring to FIG. 2, master node 118 includes the scheduler module 128 and other components 202. Worker node 116 includes the device plugin 124 and the profiler module 122. Similarly, worker node 120 includes the device plugin 134 and the profiler module 132.

The device plugins 134 and 124 can be configured to enable access to fractional GPUs as well as limit enforcement and isolation among containers. For example, device plugin 134 exposes physical GPUs 210 as virtualized GPUs (vGPUs) 214, and device plugin 124 exposes physical GPUs 208 as vGPUs 212.

The profiler module 122 comprises suitable circuitry, logic, interfaces, and/or code and is configured to collect utilization metrics, extract representations of the utilization metrics, and aggregate them as inputs of scheduling algorithms of the scheduler module 128. Profiler module 132 can perform similar functions as profiler module 122. In some aspects, profiler module 122 can be associated with a storage server (e.g., Prometheus server 206 of a Kubernetes architecture), which can be used to store metrics and metadata from worker node 116 as well as metrics and metadata 218 from profiler modules in other worker nodes (e.g., metadata from profiler module 132 of worker node 120).

The scheduler module 128 comprises suitable circuitry, logic, interfaces, and/or code and is configured to use a deep learning (DL) model to learn workload-specific scheduling policies without human input and assign workloads to a computing node (e.g., via scheduling decisions 216) to execute them while sharing GPU resources and minimizing the overall job completion time (JCT). For example, scheduler module 128 uses the AI-powered analyzer 204 to determine an optimized placement of a workload based on a scheduling algorithm. In some aspects, the AI-powered analyzer 204 is deployed at the same node as the Prometheus server for communication convenience (e.g., as illustrated in FIG. 2).

In some aspects, the scheduling algorithm used by the scheduler module 128 is based on interference detection during GPU sharing by workloads. In comparison, existing workload schedulers either only use integral GPUs or retain simple scheduling strategies without considering any interference under GPU sharing use cases.

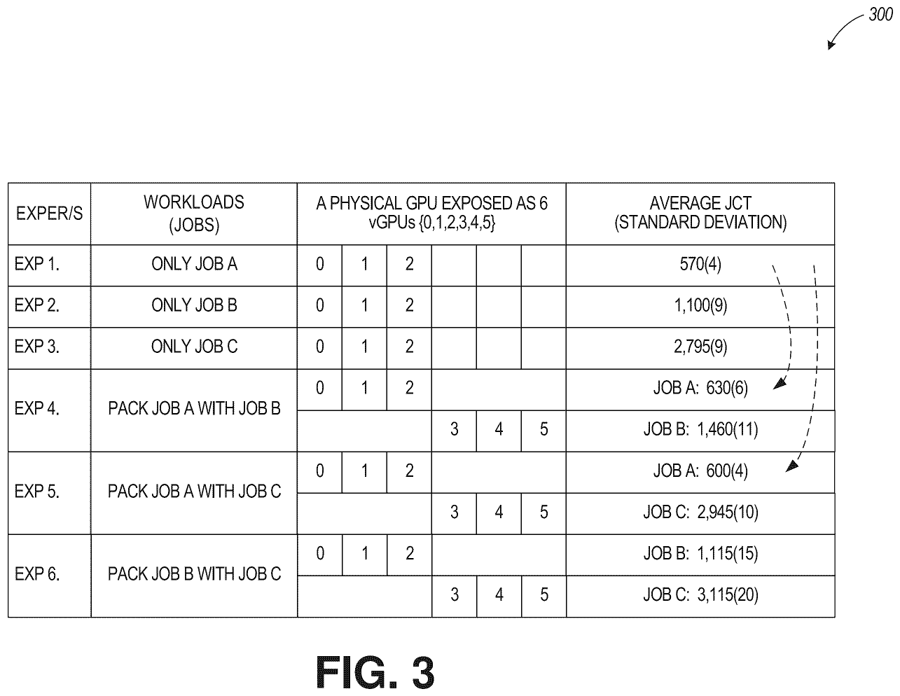

FIG. 3 is a diagram of table 300 illustrating workload (or job) packing and corresponding joint completion times for completing the workloads, according to some example embodiments. As illustrated in FIG. 3, packing two workloads into one physical GPU (e.g., packing job A with job B) can cause interference and prolong the JCTs of the workloads. FIG. 3 further illustrates that interferences can be workload-specific and workloads can be selected (e.g., using the disclosed techniques) for sharing GPU resources to minimize interference and reduce JCTs. More specifically, the workload management module 115 can use the profiler module (e.g., profiler module 122) to collect utilization metrics and leverage a DL model (e.g., as used by the AI-powered analyzer 204) to predict an optimal workload for packing with a selected workload. In some aspects, “optimal workload” can indicate a workload causing minimal interference when packed with the selected workload and/or causing minimal JCTs for each of the packed workloads.

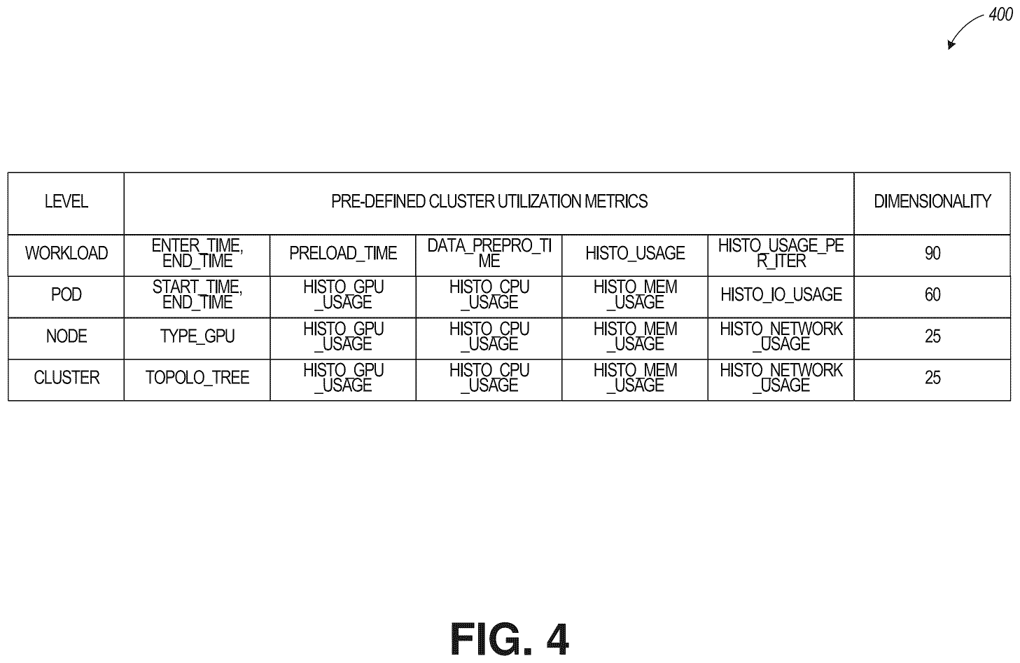

FIG. 4 is a diagram of table 400 illustrating example utilization metrics collected and used by the workload management module of FIG. 1, according to some example embodiments. Referring to FIG. 4, table 400 illustrates example cluster utilization metrics that can be collected by a profiler module and used by the AI-based scheduling algorithm (e.g., using a DL model of the AI-powered analyzer 204). In some aspects, the DL model can be trained using the utilization metrics listed in table 400.

Some example utilization metrics illustrated in FIG. 4 include histo_gpu_usage (indicating a histogram of GPU usage by a pod), histo_mem_usage (indicating a histogram of memory usage in a node), and type_GPU (indicating the GPU type, such as Tesla V100, Geforce RTX 2080, Ti, RTX 8000, Titan X, etc.). Additional utilization metrics are provided in Table 2 below.

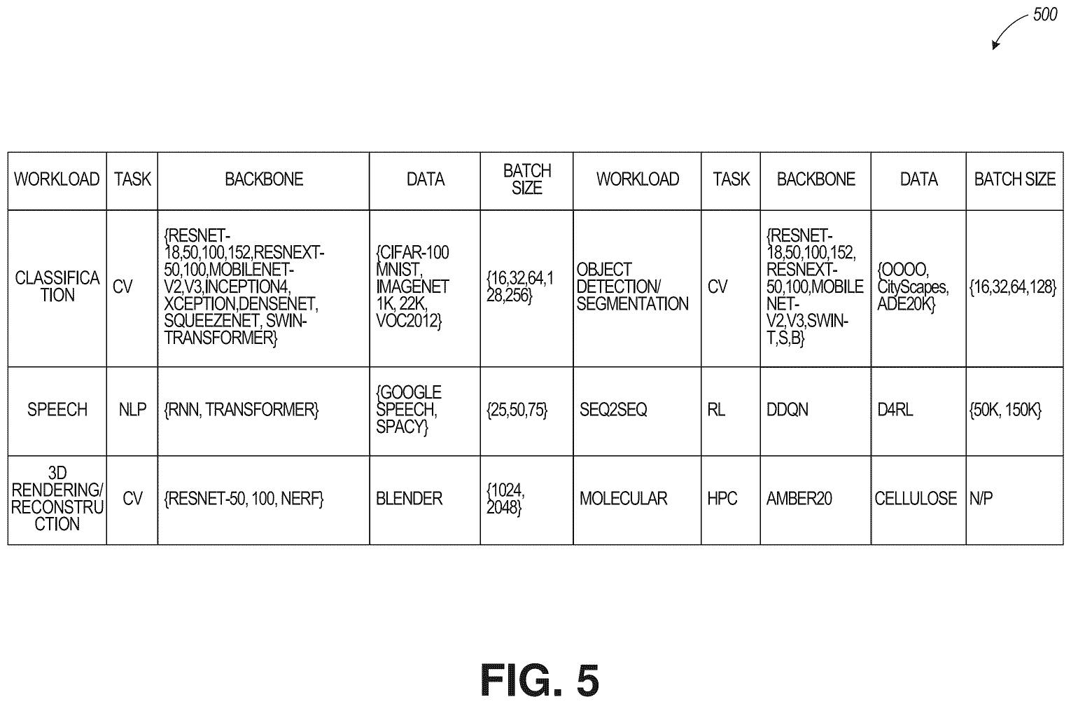

FIG. 5 is a diagram illustrating example workloads 500 which can be managed by the workload management module of FIG. 1, according to some example embodiments. In some aspects, the DL model (e.g., as used by the AI-powered analyzer 204) can be trained using utilization metrics collected by a profiler module while training workloads (e.g., including the workloads illustrated in FIG. 5) are executed by worker nodes of the network-based service infrastructure 114.

FIG. 6 is a block diagram illustrating an example device plugin architecture 600 used in connection with workload management, according to some example embodiments. Referring to FIG. 6, the device plugin architecture 600 includes a Kubernetes application programming interface (K8S API) server 602, a K8S scheduler 604, a K8S kubelet 606, a docker (or container management tool) 624, device plugin 608, container 626, host file system 634, physical GPU resources 614, GPU user space driver 616, and GPU kernel space driver 622. The K8S API server 602, the K8S scheduler 604, the K8S kubelet 606, and docker 624 can be modules configured as part of Kubernetes-based network architecture.

The device plugin 608 includes a K8S device plugin 610 (with GPU manager) and a virtual GPU registration server 612. The container 626 can be used for configuring a vGPU library 632 as well as to execute workloads 628 and 630. The GPU user space driver 616 includes a GPU driver API 618 (also referred to as Compute Unified Device Architecture or CUDA) and a GPU monitoring API 620 (also referred to as NVIDIA Management Library API or NVML API).

In a Kubernetes infrastructure, processing can be based on an assumption that all K8S devices/modules on a node are the same and that GPU usage is exclusive at the container level. When workload scheduling uses GPUs on the same nodes, existing APIs may not allow for expressing GPU requirements (such as same GPU sharing between containers) or GPU hardware features (memory, compute capabilities, etc.) in the K8S pod specifications.

In some embodiments, the device plugin 608 uses a Kubernetes extension mechanism to enable the Kubernetes-managed containers to access GPUs. In comparison to the NVIDIA device plugin, the disclosed device plugin 608 can provide fractional GPUs (a.k.a., vGPUs), with vGPU usage limiting enforcement and vGPU isolation among containers. These features can be implemented via a K8S LD_PRELOAD mechanism.

In some aspects, the LD_PRELOAD mechanism is a technique to influence the linkage of shared libraries and the resolution of symbols (functions) at runtime. In brief, a library is a collection of compiled functions that can be simply used without rewriting. This can be achieved by either including the library code in your program (e.g., a static library) or by linking dynamically at runtime (e.g., a shared library). In some aspects, the shared library that a program is built with can require runtime linker/loader support. For this reason, required symbols can be loaded and prepared before executing a program. In some aspects, the LD_PRELOAD mechanism can be used in the program execution preparation phase. In some aspects, Linux system programs ld.so and ld-linux.so (dynamic linker/loader) can use LD_PRELOAD to load specified shared libraries. Before any other library, the dynamic loader can first load shared libraries that are in LD_PRELOAD. Therefore, once a user wants to share GPU memory and computing resources among multiple isolated containers, a special library, the GPU driver API 618 is intercepted via the LD_P PRELOAD mechanism. In some aspects, the intercept is performed at this level to support CUDA-based applications and have a stable public API.

As illustrated in FIG. 6, the overall architecture of the device plugin 608 includes three components: the K8S device plugin 610, the vGPU registration server 612, and the vGPU library 632 (also referred to as libintercept.so in FIG. 6).

The K8S device plugin 610 is used to advertise GPUs to the K8S kubelet 606. The K8S device plugin 610 runs on the host and is responsible for creating vGPUs using the physical GPU resources 614 and communicating with the K8S kubelet 606 through remote procedure call API (e.g., gRPC) service.

The K8S device plugin 610 registers itself with the K8S kubelet 606 via a register, request, and allocate call 636 to inform the kubelet of its existence. When a user requires GPU devices in a container specification, the kubelet arbitrarily selects the corresponding number of devices from the device list sent by the K8S device plugin.

After successful registration, the kubelet sends a ListAndWatch request 638 to the GPU manager of the K8S device plugin for inquiring about device information. The GPU manager returns a list of devices it manages to the kubelet. Instead of physical GPUs, a list of vGPUs is sent to the kubelet. In some aspects, physical GPU resources 614 are virtualized in two resource dimensions: memory and computing resources.

The vGPU registration server 612 is configured to run on the host to deliver container configurations and monitor containers assigned with vGPUs. When a container applies for GPU resources, the server sends the container's configuration (such as the required GPU resources) and the name of the container to the vGPU manager of the K8S device plugin 610.

The vGPU library 632 is running in container 626 and is used to manage the GPU resources. The vGPU library 632 can be launched when the first GPU application is executed in container 626. The vGPU library 632 registers itself with the vGPU manager after booting. It intercepts the memory-related APIs and the computing-related APIs in the CUDA library by the LD_LIBRARY PATH mechanism. In some aspects, LD_LIBRARY PATH is an environment variable for Linux systems that affects the runtime link of programs, which allows some directories to be loaded before the standard set of directories.

In some embodiments, the following processing flow can be performed by the device plugin architecture 600. The GPU manager of K8S device plugin 610 registers itself to the kubelet 606 with vGPUs, then ListAndWatch request 638 is processed. Once the kubelet receives a GPU request, it sends the request to the GPU manager. The GPU manager sends a scheduling request to the scheduler, and the scheduler returns a response with allocated GPUs. The GPU manager sends the response to the vGPU registration server 612. The GPU manager returns the container's environment variables, mounting information (e.g., host file system 634 mounted on container 626), and device information to the kubelet. The kubelet creates and initializes container 626. Before the container executes, GPU driver APIs (e.g., CUDA APIs) are intercepted by the LD_LIBRARY mechanism, which allows some directories to be loaded first. Container 626 is deployed with vGPUs. The vGPU server 612 manages the vGPU resources and cleans up the containers when they are deactivated.

FIG. 7 is a block diagram illustrating an example profiler architecture 700 used in connection with workload management, according to some example embodiments. Referring to FIG. 7, the profiler architecture 700 includes computing nodes implementing components of a workload management module such as a scheduler module 710, profiler modules 718 and 730, and device plugins 712 and 736. More specifically, the profiler architecture includes a master node 702 with an API server 708 and the scheduler module 710, and worker nodes 704, . . . , 706. Worker node 704 includes GPUs 728, the profiler module 718, the device plugin 712, a GPU driver API 714, and container runtime 716. The profiler module 718 includes an AI-powered analyzer (which can be a component of the scheduler module 710), a K8S Prometheus server 722, CPU metrics collector module 724, and GPU metrics collector module 726. Worker node 706 includes GPUs 742, the profiler module 730, the device plugin 736, a GPU driver API 738, and container runtime 740. The profiler module 730 includes CPU metrics collector module 732 and GPU metrics collector module 734.

The scheduler module 710, the AI-powered analyzer module 720, the profiler modules 718 and 730, and the device plugins 712 and 736 are similar in function to the corresponding modules discussed in connection with FIG. 1-FIG. 6.

The profiler modules 718 and 730 can be configured to collect and analyze GPU metrics at various levels, such as pod level, node level, job/workload level, GPU level, CPU level, memory level, and network traffic. Table 2 below provides example metrics that can be defined, collected, and stored by the profiler modules 718 and 730.

TABLE 2

| Attribute | | |
|---|---|---|
| ID | Attribute | Attribute Description |
| 1 | ID | Task ID |
| 2 | Model | Architecture of ML |
| | | model used |
| 3 | Dataset | Dataset used for the task |
| 4 | Epoch | Number of iterations for training |
| | | the ML model |
| 5 | BS | Batch Size |
| 6 | Run Env | Runtime Environment |
| 7 | CPU Util % ran | CPU Utilization percent range |
| 8 | Max CPU Util % | Maximum CPU Utilization |
| | | percent |
| 9 | Min CPU Util % | Minimum CPU Utilization |
| | | percent |
| 10 | GPU Util % ran | GPU Utilization percent range |
| 11 | MGUP | Maximum GPU Utilization |
| | | percent |
| 12 | Min GPU Util % | Minimum GPU Utilization |
| | | percent |
| 13 | Sys Mem Util % | System Memory Utilization |
| | ran | percent range |
| 14 | Max Sys Mem | Maximum System Memory |
| | Util % | Utilization percent |
| 15 | Min Sys Mem | Minimum System Memory |
| | Util % | Utilization percent |
| 16 | MaPMiU | Maximum Process Memory in |
| | (non-swap) | Use (non-swap) |
| 17 | PMiU (non-swap) | Process Memory in Use |
| | % | (non-swap) percent |
| 18 | CPU Thds | CPU Threads |
| 19 | GPU Temp ran | GPU Temperature range |
| 20 | Max GPU Temp | Maximum GPU Temperature |
| 21 | Min GPU Temp | Minimum GPU Temperature |
| 22 | GTSAMPR | GPU Time spent accessing |
| | | memory percent range |
| 23 | MaGTSAMP | Maximum GPU Time spent |
| | | accessing memory percent |
| 24 | MiGTSAMP | Minimum GPU Time spent |
| | | accessing memory percent |
| 25 | MGMAP | Maximum GPU Memory |
| | | Allocated percent |
| 26 | GPUPR | GPU Power Usage percent range |
| 27 | MaGPUPR | Maximum GPU Power Usage |
| | | percent |
| 28 | MiGPUPR | Minimum GPU Power Usage |
| | | percent |
| 29 | SCT user | In user mode, execution time of |
| | | normal processes |
| 30 | SCT nice | In user mode, execution time of |
| | | priority processes |
| 31 | SCT sys | In kernel mode, execution time |
| | | of processes |
| 32 | SCT idle | System idle time |
| 33 | SCT iowait | Input-output completion time |
| | | (not accounted in idle time |
| | | counter) |
| 34 | SCT inq | Time to service hardware |
| | | interrupts |
| 35 | SCT softinq | Time to service software |
| | | interrupts |
| 36 | SCT steal | Time consumed by operating |
| | | systems (OS) running in |
| | | virtualized environment |
| 37 | SCT guest | Time consumed to run a virtual |
| | | CPU for guest OS under |
| | | the control of the Linux |
| | | kernel |
| 38 | SCT guest nice | Time consumed running a virtual |
| | | CPU for guest OS while |
| | | executing priority |
| | | processes executing in |
| | | user mode |
| 39 | Cor in Sys | Number of Cores in the System |
| 40 | CS ctx switches | Number of context switches since |
| | | boot |
| 41 | CS interrupts | Number of interrupts since boot |
| 42 | CS soft | Number of software interrupts |
| | interrupts | since boot |
| 43 | CS syscalls | Number of system calls since |
| | | boot. Always set to 0 in |
| | | Ubunits. |
| 44 | SMU total | Total available physical memory |
| | | (excluding swap) |
| 45 | SMU available | Memory that can be assigned to |
| | | processes without any |
| | | system swap |
| 46 | SMU percent | Percent of memory used |
| 47 | SMU used | Memory used |
| 48 | SMU free | Available memory |
| 49 | SMU active | Memory currently in use (or very |
| | | recently used) |
| 50 | SMU inactive | Memory marked as unused |
| 51 | SMU buffers | Cache data like file system, |
| | | storing metadata |
| 52 | SMU cached | Cached data |
| 53 | SMU shared | Memory that may be accessed by |
| | | multiple processes |
| 54 | SMU slab | In-kernel data structures cache |
| 55 | DU total | Total disk space |
| 56 | DU used | Used disk space |
| 57 | DU free | Free disk space |
| 58 | DU percent | Disk usage percent |
| 59 | NIOB sent | Number of bytes sent |
| 60 | NIOB received | Number of bytes received |
| 61 | NIOP sent | Number of packets sent |
| 62 | NIOP received | Number of packets received |
| 63 | NIO errin | Total number of errors while |
| | | receiving I/O signals |
| 64 | NIO errout | Total number of errors while |
| | | sending I/O signals |
| 65 | NIO dropin | Total number of dropped |
| | | incoming packets |
| 66 | NIO dropout | Number of dropped outgoing |
| | | packets |

The GPU metrics collector modules 726 and 734 can include NVIDIA's data center GPU manager (DCGM) for collecting the disclosed utilization metrics (e.g., the metrics listed in Table 1 and Table 2) and storing them in server 722. The CPU metrics collector modules 724 and 732 are used for collecting CPU metrics and storing them in server 722. In some aspects, a single Prometheus server can be used per cluster.

The AI-powered analyzer module 720 is configured to read metrics from server 722, determine workload type (e.g., classify a workload as “seen” or “unseen”) using a DL model, update utilization metrics stored in server 722 with metrics from a dry-run process (e.g., as discussed in connection with FIG. 8), and restore scheduling decisions.

In some aspects, analytical functions (e.g., cyclic pattern detection and trend forecasting) are built in the profiler (e.g., via the AI-powered analyzer module 720) to predict workload type, utilization, etc. Analytical results are written back in server 722 as part of objects' annotations. Additionally, the profiler modules 718 and 730 can generate short-term trial workloads (i.e., dry-run) with different device placements (assign different types and numbers of GPUs) and track the execution efficiency. Therefore, the proposed scheduling algorithm can perform dynamic optimization considering the trial workload results.

FIG. 8 is a block diagram of an example workflow 800 for scheduling of workloads, according to some example embodiments. The example operations (or steps) in FIG. 8 can be performed by components of a workload management module disclosed herein, such as a scheduler module 804, a profiler module 808, and an AI-powered analyzer module 810 with a trained DL model 812.

At operation 0, a new job (or workload) 802 is received by the scheduler module 804. Initialized parameters of the trained DL model 812 are learned via an offline training stage. During the offline training, multiple (e.g., approximately 1000) GPU-related workloads can be profiled by the profiler module 808 under a simulated environment. Making use of the above-mentioned profiling metrics, two types of metadata can be recorded and analyzed: (a) A single job on a single GPU (the metadata of workload i is denoted as Fᵢ and the JCT is denoted as Tᵢ; and (b) Two jobs packed into a single GPU (the JCT of packing jobs i and j is denoted as Tᵢⱼ, and the table with all available packing JCTs can be referred to as a packing table).

Operations 1, 2, and 3. To predict the optimal workload partner for packing with the new workload 802, each coming workload will first be allocated to a single idle GPU and executed for a pre-defined time (also referred to as a dry run). For example, a dry run 806 for the new workload 802 is performed. Scheduler module 804 can arbitrarily allocate the workload to a single GPU and let it run its first iteration. The profiler module 808 estimates the utilization metrics of workload 802 and denoted it as Fₙ, which is the input to the AI-powered analyzer module 810 with the trained DL model 812.

At operation 4, categorization of workload 802 can be performed. The trained DL model 812 in the AI-powered analyzer module 810 can categorize workload 802 into at least ten types (or classes): nine seen (or previously known) workload type and one unseen (or previously unknown) workload type according to its utilization metrics. At operation 814, if workload 802 belongs to the seen type, processing continues at operation 5b. At operation 814, if workload 802 belongs to the unseen type, processing continues at operation 5a where the dry running is maintained until it completes.

Operations 5b and 6b are associated with elimination functionalities. If workload 802 is categorized into one of the seen types (e.g., one of the nine seen types), its dry run will be terminated at operation 5b (also referred to as operation 820). Workload 802 will be re-allocated (e.g., by the scheduler module 804) to other GPUs according to the packing table, where an optimal workload partner can be selected (e.g., at operation 816) for sharing the GPU with respect to minimizing JCTs of the workloads. In some aspects, the packing table is built during the offline training stage in Operation 0.

Operations 5a and 6a are associated with online learning functionalities for the trained DL model 812. If workload 802 is categorized into the unseen class of workloads, its dry run process will continue (at operation 818) until the workload is completed. The corresponding utilization metrics and metadata of the executed workload will be recorded by the profiler module 808, and the AI-powered analyzer module 810 (e.g., the packing table used by the analyzer) is updated at operation 822. In some aspects, the update includes two sub-operations: a) increase the number of seen classes by 1, and b) update the packing table with the metadata of this workload.

FIG. 9 is a diagram with example pseudo-code 900 associated with the workflow of FIG. 8, according to some example embodiments.

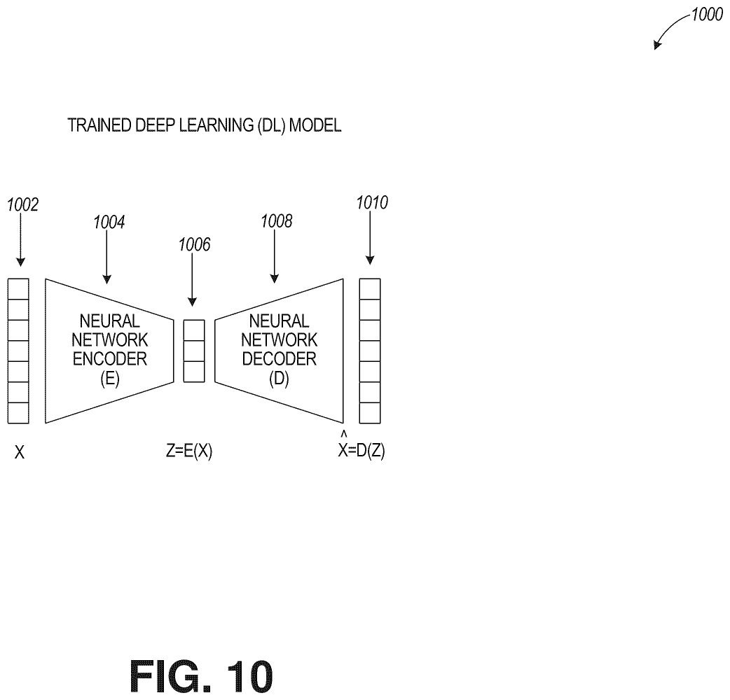

FIG. 10 is a diagram of an example trained DL model 1000 used in connection with workload management, according to some example embodiments. DL model 1000 can be the same as the trained DL model 812 discussed in connection with FIG. 8.

In some embodiments, DL model 1000 includes a neural network encoder 1004 and a neural network decoder 1008. The DL model 1000 can be used to predict whether an incoming (or new) workload (e.g., workload 802) belongs to a type (or a class) of a plurality of seen types (or classes) detected during offline simulation and training of the DL model 1000.

In some aspects, encoder 1004 can be configured for dimensionality reduction. For example, input 1002 can be configured as input X=[m_1, m_2] and can include utilization metrics collected from multiple (e.g., approximately 1,000) workloads with dimensionality of 200. The encoder output 1006 can be designated as output Z=E(x), where E is a transformation function that reduces the dimensionality to 10 (e.g., nine seen classes and one unseen class). The encoder output 1006 is also the input to decoder 1008, and decoder 1008 generates output 1010. The output 1010 can be designated as \hat{X}=D(Z), where D is a second transformation function based on the output Z of the encoder 1004.

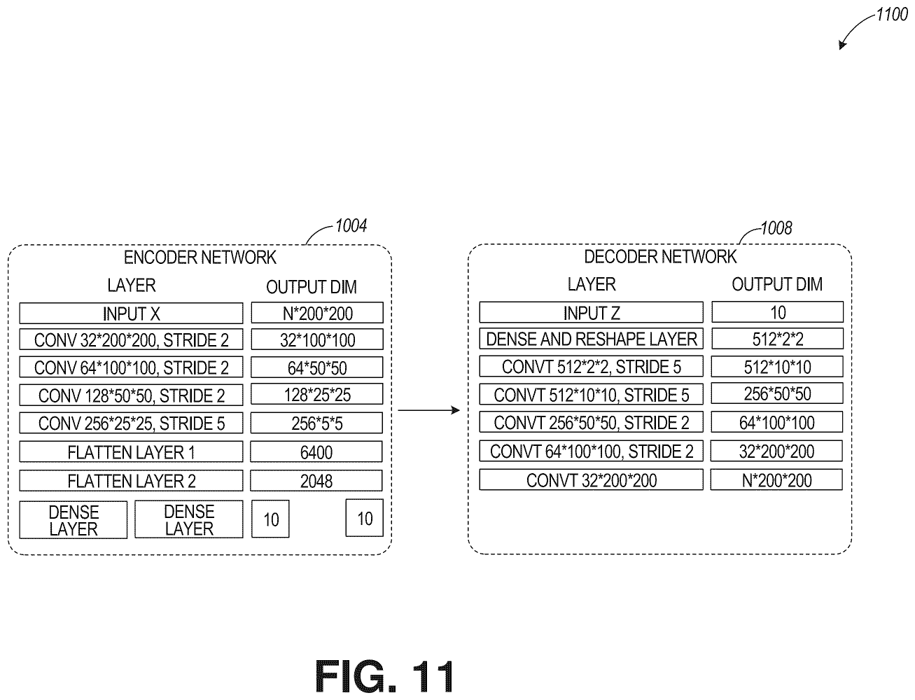

FIG. 11 is diagram 1100 of an encoder network and a decoder network of the DL model of FIG. 10, according to some example embodiments. More specifically, FIG. 11 illustrates a detailed diagram showing convolutional layers and dimensionalities associated with the encoder 1004 and decoder 1008 used by the DL model 1000 of FIG. 10.

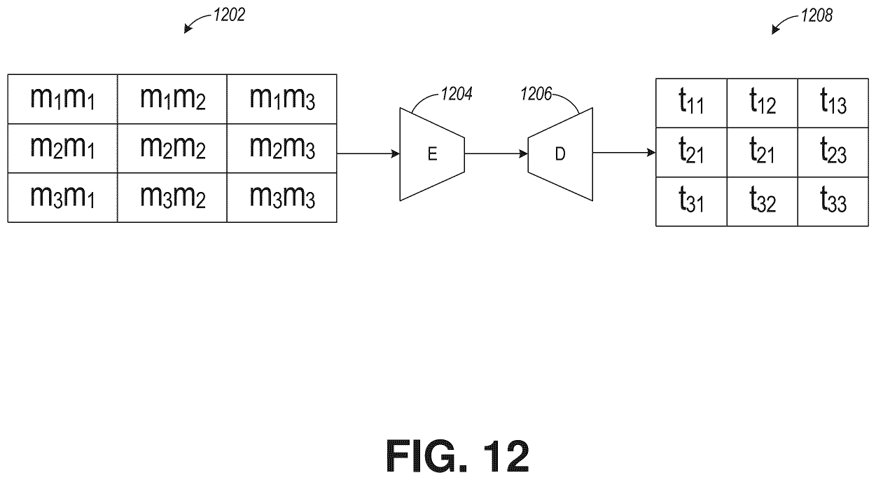

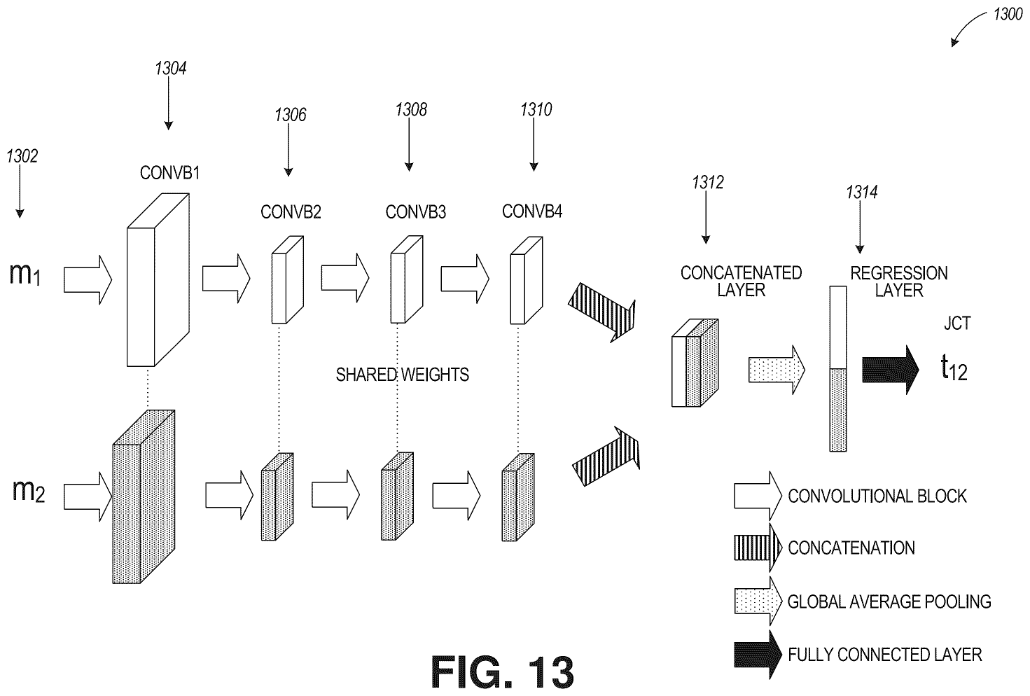

FIG. 12 and FIG. 13 are diagrams of training the DL model of FIG. 10, according to some example embodiments. Referring to FIG. 12, diagram 1200 is a supervised training stage of the DL model 1000. More specifically, matrices table 1202 can be used as input to encoder 1204, and packing table 1208 can be used as the output of decoder 1206. Matrices table 1202 includes matrices mᵢmⱼ of utilization metrics for workloads i and j. Packing table 1208 includes JCTs tᵢⱼ when workloads i and j are packed together for sharing a GPU resource.

FIG. 13 illustrates diagram 1300 of a more detailed view of training the DL model 1000. Referring to FIG. 13, the training of the DL model uses utilization metrics m1 and m2 as input 1302 to the first convolutional layer 1304 of the encoder 1204. Additional convolutional layers 1306, 1308, and 1310 can be applied before generating a concatenated layer 1312 using encoder outputs from convolutional layer 1310 corresponding to utilization metrics m1 and m2. A regression layer 1314 can be applied to the output of the concatenated layer 1312 to generate JCT t₁₂ as the output of the DL model 1000.

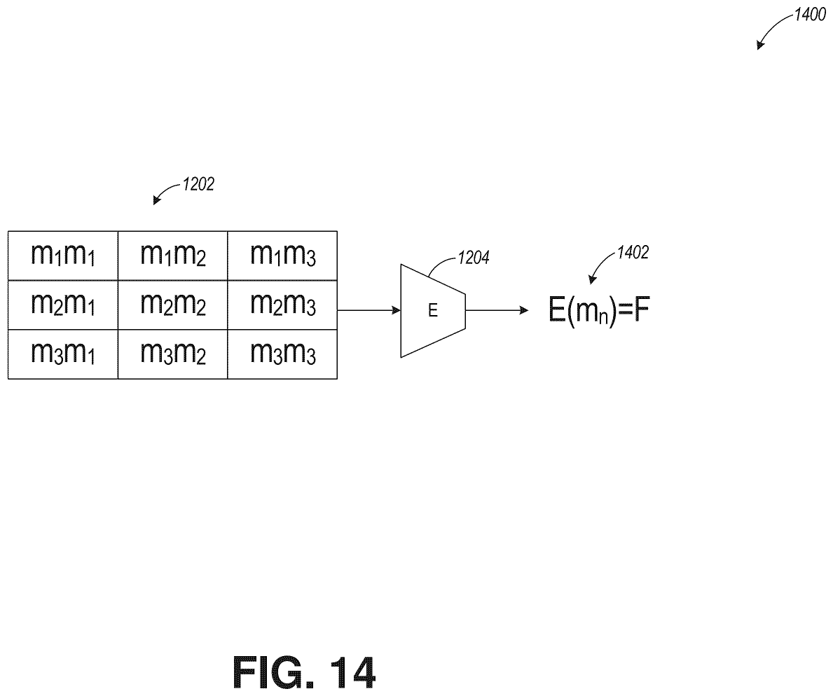

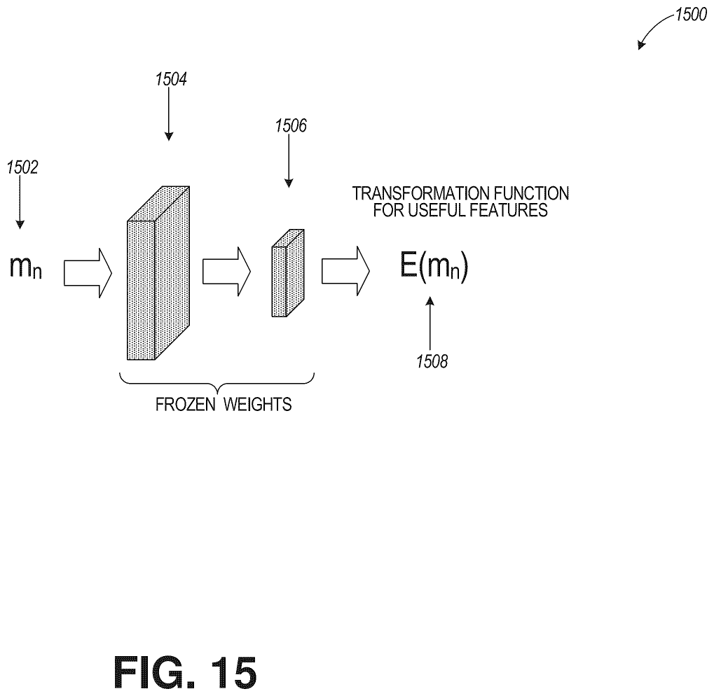

FIG. 14 and FIG. 15 are diagrams illustrating the generation of a transformation function for workload scheduling using the encoder network of the DL model of FIG. 10, according to some example embodiments.

Referring to FIG. 14, diagram 1400 illustrates matrices table 1202 includes matrices mᵢmⱼ of utilization metrics for workloads i and j, which can be provided as input to encoder 1204 of the DL model 1000. The output of encoder 1204 is a useful feature set F 1402 corresponding to a transformation function E(m). In some aspects, E is a transformation function that reduces the dimensionality to 10. In some embodiments, the useful feature set F 1402 is a subset of the utilization metrics for each of the workloads. In this regard, the term “useful feature set” is used in connection with the disclosed techniques to indicate a subset of utilization metrics generated as an output of a DL model encoder which uses matrices of workload utilization metrics as input.

The following is an example of how the useful feature set can be used by the AI-powered analyzer module of the scheduler module disclosed herein. For each new workload n, the scheduler module will assign it to a single idle GPU and execute the workload for a pre-defined time (e.g., as discussed in connection with FIG. 8). Utilization metrics from workload n are collected and denoted as mₙ. The workload type can be determined by categorizing the workload into at least one workload type of a prior workload with utilization metrics m1. The following functionalities can be performed by the workload management module 115 to determine the workload type:
(a) if |F (mₙ)−F(m₁)|₂<=θ, workload n belongs to type 1 associated with the prior workload with utilization metrics m1 (where θ is a pre-defined threshold value and F is the useful feature set determined for the new workload n as well as the prior workload 1). In some aspects, the workload management module 115 can configure a shared execution of workloads (e.g., the prior workload and the new workload) when the useful feature set for the prior workload is different from the useful feature set of the new workload by not more than the threshold value 0.
(b) if |F(mₙ)−F(m₁)|₂>=θ, workload n is an unseen type. In some aspects, the workload management module 115 can refrain from configuring the shared execution of workloads (e.g., the prior workload and the new workload) when the useful feature set for the prior workload is different from the useful feature set of the new workload by more than the threshold value 0.

After the dry run (e.g., dry run 806), if workload n falls into any known types (or classes), the packing table can be explored to find an optimal workload partner to pack with workload n (e.g., to minimize interference and JCT). If workload n falls into an unseen type (e.g., no match to a known type is made), the scheduler can refrain from configuring a shared execution of workloads. In this case, the dry run can continue until the workload n is completed and its utilization metrics are profiled (e.g., as a new type that can be used to match with a subsequent workload). In this regard, the packing table is updated with the new workload type after the dry run of workload n is completed.

In some embodiments, the disclosed AI-based scheduling algorithm considers the interference pattern of multiple AI jobs, and schedules jobs to share a GPU with least interference of the jobs. In some aspects, the interference patterns among various AI jobs are obtained offline through AI training itself. In other words, the patterns were detected based on AI training on the data from running these jobs sharing GPUs.

FIG. 15 illustrates diagram 1500 of obtaining a transformation function E(m) 1508 using convolutional layers of the encoder of the DL model 1000. More specifically, utilization metrics 1502 are provided as input to the DL model encoder. In some aspects, transformation function E(m) 1508 is generated using a subset of the convolutional layers of the encoder. In the example illustrated in FIG. 15, transformation function E(m) 1508 is generated by freezing the weights of convolutional layers 1504 and 1506, with the transformation function 1508 being the output of the second convolutional layer 1506. Other configurations for generating the transformation function using a subset of encoder convolutional layers can be used as well.

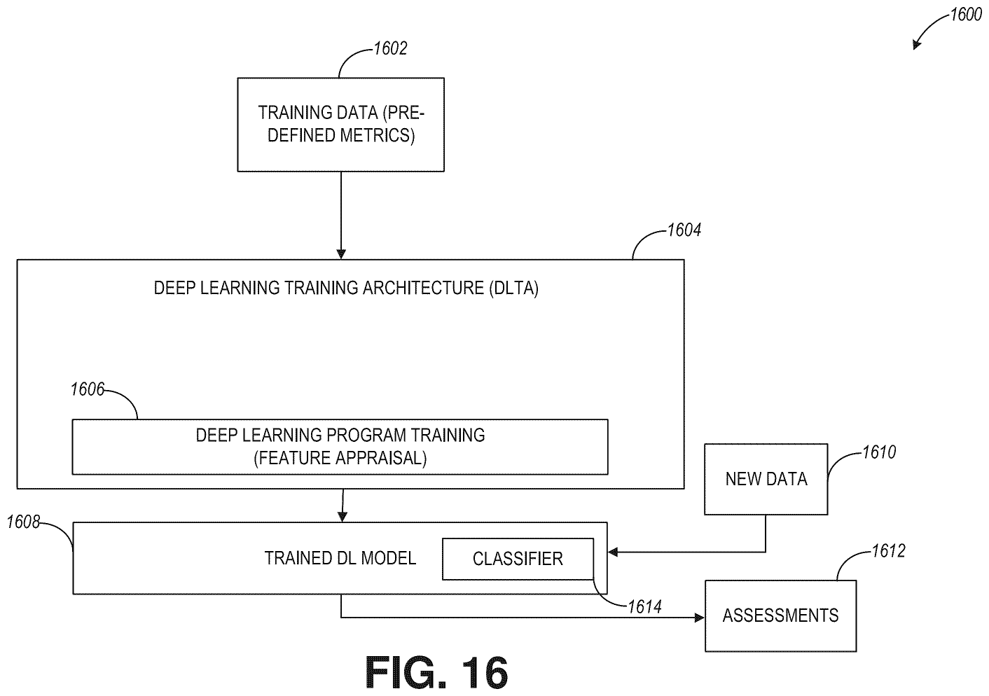

FIG. 16 is a block diagram 1600 illustrating the training of deep learning (DL) model 1608 using a DL training architecture (DLTA) 1604, according to some example embodiments. In some example embodiments, machine-learning programs (MLPs), including deep learning programs, also collectively referred to as machine-learning algorithms or tools, are utilized to perform operations associated with correlating data or other artificial intelligence (AI)-based functions.

As illustrated in FIG. 16, deep learning program training 1606 can be performed within the DLTA 1604 based on training data 1602 (which can include utilization metrics or other pre-defined metrics corresponding to pre-defined outputs). During the deep learning program training 1606, features from the training data 1602 can be assessed for purposes of further training of the DL model 1608. The DL program training 1606 results in a trained DL model 1608 which can include one or more classifiers 1614 that can be used to provide assessments 1612 based on new data 1610. The trained DL model 1608 can be the same as the trained DL model 812 used by the AI-powered analyzer module 810.

Deep learning is part of machine learning, which is a field of study that gives computers the ability to learn without being explicitly programmed. Machine learning explores the study and construction of algorithms, also referred to herein as tools, that may learn from existing data, correlate data, and make predictions about new data. Such machine learning tools operate by building a model from example training data (e.g., training data 1602) to make data-driven predictions or decisions expressed as outputs or assessments 1612. Although example embodiments are presented concerning a few machine-learning tools (e.g., a deep learning training architecture), the principles presented herein may be applied to other machine-learning tools.

In some example embodiments, different machine learning tools may be used. For example, Logistic Regression (LR), Naive-Bayes, Random Forest (RF), neural networks (NN), matrix factorization, and Support Vector Machines (SVM) tools may be used during the program training 1606 (e.g., for correlating the training data 1602).

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). In some embodiments, the DLTA 1604 can be configured to use machine learning algorithms that utilize the training data 1602 to find correlations among identified features that affect the outcome.

The machine learning algorithms utilize features from the training data 1602 for analyzing the new data 1610 (e.g., utilization metrics of a new workload) to generate the assessments 1612 (e.g., the assessment of the workload type made at operation 814 in FIG. 8). The features include individual measurable properties of a phenomenon being observed and used for training the ML program. The concept of a feature is related to that of an explanatory variable used in statistical techniques such as linear regression. Choosing informative, discriminating, and independent features is important for the effective operation of the MLP in pattern recognition, classification, and regression. Features may be of different types, such as numeric features, strings, and graphs. In some aspects, training data can be of different types, with the features being numeric for use by a computing device.

The machine learning algorithms utilize the training data 1602 to find correlations among the identified features that affect the outcome of assessments 1612. In some example embodiments, the training data 1602 includes labeled data, which is known data for one or more identified features and one or more outcomes. With the training data 1602 (which can include identified features), the DL model is trained using the DL program training 1606 within the DLTA 1604. The result of the training is the trained DL model 1608. When the DL model 1608 is used to perform an assessment, new data 1610 is provided as an input to the trained DL model 1608, and the DL model 1608 generates the assessments 1612 as an output.

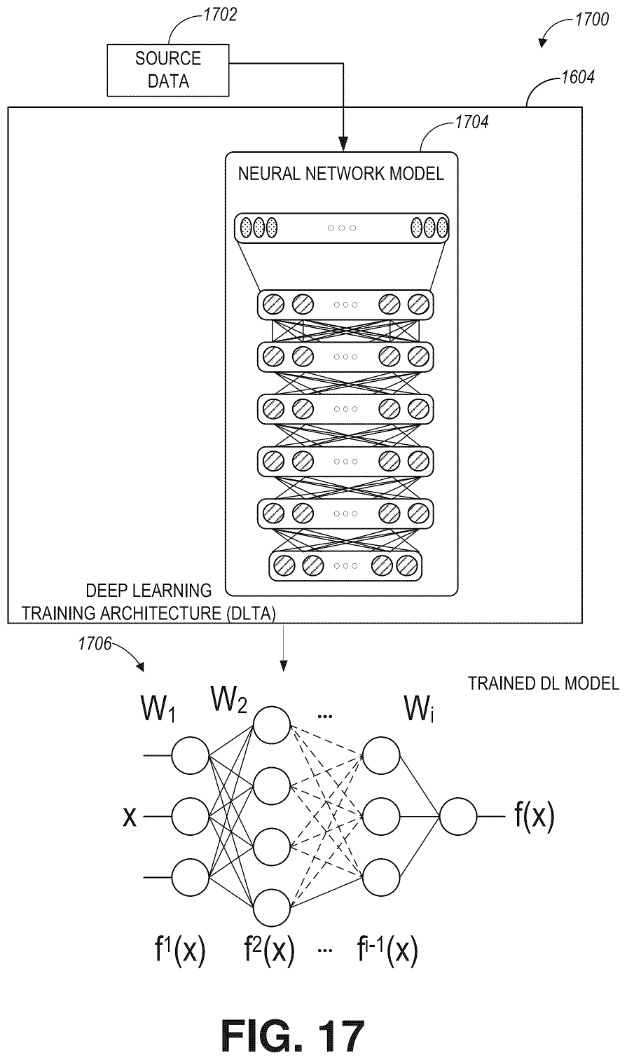

FIG. 17 is a diagram 1700 illustrating the generation of a trained DL model 1706 using a neural network model 1704 trained within a DLTA 1604, according to some example embodiments. Referring to FIG. 17, source data 1702 can be analyzed by a neural network model 1704 (or another type of machine learning algorithm or technique) to generate the trained DL model 1706 (which can be the same as the trained DL model 1608). The source data 1702 can include a training set of data, such as training data 1602, including data identified by one or more features. As used herein, the terms “neural network” and “neural network model” are interchangeable.

Machine learning techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to predict the output for a given input correctly. Generally, the learning phase may be supervised, semi-supervised, or unsupervised, indicating a decreasing level to which the “correct” outputs are provided in correspondence to the training inputs. In a supervised learning phase, all of the outputs are provided to the model, and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs, in which the training dataset is repeatedly fed into the model to refine its results (i.e., the entire dataset is processed during an epoch). During an iteration, the model (e.g., a neural network model or another type of machine learning model) is run against a mini-batch (or a portion) of the entire dataset. In a supervised learning phase, a model is developed to predict the output for a given set of inputs (e.g., source data 1702) and is evaluated over several epochs to more reliably provide the output that is specified as corresponding to the given input for the greatest number of inputs for the training dataset. In another example, for an unsupervised learning phase, a model is developed to cluster the dataset into n groups and is evaluated over several epochs as to how consistently it places a given input into a given group and how reliably it produces the n desired clusters across each epoch.

Once an epoch is run, the models are evaluated, and the values of their variables (e.g., weights, biases, or other parameters) are adjusted to attempt to better refine the model iteratively. As used herein, the term “weights” refers to the parameters used by a machine learning model. During a backward computation, a model can output gradients, which can be used for updating weights associated with a forward computation.

In various aspects, the evaluations are biased against false negatives, biased against false positives, or evenly biased concerning the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to the desired result, but as the training dataset may be varied and is preferably very large, perfect accuracy and precision may not be achievable. Several epochs that make up a learning phase, therefore, may be set as a given number of trials or a fixed time/computing budget or may be terminated before that number/budget is reached when the accuracy of a given model is high enough or low enough or an accuracy plateau has been reached. For example, suppose the training phase is designed to run n epochs and produce a model with at least 95% accuracy, and such a model is produced before the nth epoch. In that case, the learning phase may end early and use the produced model satisfying the end-goal accuracy threshold. Similarly, suppose a given model is inaccurate enough to satisfy a random chance threshold (e.g., the model is only 55% accurate in determining true/false outputs for given inputs). In that case, the learning phase for that model may be terminated early, although other models in the learning phase may continue training. Similarly, when a given model continues to provide similar accuracy or vacillate in its results across multiple epochs-having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine the accuracy of the model in handling data that has not been trained on. In a second example, a false positive rate or false negative rate may be used to evaluate the models after finalization. In a third example, a delineation between data clusters in each model is used to select a model that produces the clearest bounds for its clusters of data.

In some example embodiments, the DL model 1706 is trained by the neural network model 1704 (e.g., deep learning, deep convolutional, or recurrent neural network), which comprises a series of “neurons,” such as Long Short Term Memory (LSTM) nodes, arranged into a network. A neuron is an architectural element used in data processing and artificial intelligence, particularly machine learning, that includes memory that may determine when to “remember” and when to “forget” values held in that memory based on the weights of inputs provided to the given neuron. Each of the neurons used herein is configured to accept a predefined number of inputs from other neurons in the network to provide relational and sub-relational outputs for the content of the frames being analyzed. Individual neurons may be chained together and/or organized into tree structures in various configurations of neural networks to provide interactions and relationship-learning modeling for how each of the frames in an utterance is related to one another.

For example, an LSTM serving as a neuron includes several gates to handle input vectors (e.g., phonemes from an utterance), a memory cell, and an output vector (e.g., contextual representation). The input gate and output gate control the information flowing into and out of the memory cell, respectively, whereas forget gates optionally remove information from the memory cell based on the inputs from linked cells earlier in the neural network. Weights and bias vectors for the various gates are adjusted throughout a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

Neural networks utilize features for analyzing the data to generate assessments (e.g., recognizing units of speech). A feature is an individual measurable property of a phenomenon being observed. The concept of the feature is related to that of an explanatory variable used in statistical techniques such as linear regression. Further, deep features represent the output of nodes in hidden layers of the deep neural network.

A neural network is sometimes referred to as an artificial neural network or a neural network model (e.g., neural network model 1704) and can include a computing system based on the consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and, having learned the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network that is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function to determine whether and to what extent that signal progresses further through the network to affect the outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that filter the results of the inputs and are used by the following convolution layer.

In the training of a DNN architecture, a regression, which is structured as a set of statistical processes for estimating the relationships among variables, can include the minimization of a cost function. The cost function may be implemented as a function to return a number representing how well the neural network performed in mapping training examples to correct output. In training, if the cost function value is not within a predetermined range, based on the known training images, backpropagation is used, where backpropagation is a common method of training artificial neural networks that are used with an optimization method such as stochastic gradient descent (SGD) method.

The use of backpropagation can include propagation and weight updates. When an input is presented to the neural network, it is propagated forward through the neural network, layer by layer, until it reaches the output layer. The output of the neural network is then compared to the desired output using the cost function, and an error value is calculated for each of the nodes in the output layer. The error values are propagated backward, starting from the output, until each node has an associated error value, which roughly represents its contribution to the original output. Backpropagation can use these error values to calculate the gradient of the cost function concerning the weights in the neural network. The calculated gradient is fed to the selected optimization method to update the weights and attempt to minimize the cost function.

Even though the training architecture 1604 is referred to as a deep learning training architecture using a neural network model (and the program that is trained is referred to as a trained deep learning model, such as DL model 1608 or DL model 1706), the disclosure is not limited in this regard and other types of machine learning training architectures may also be used for model training, using the techniques disclosed herein.

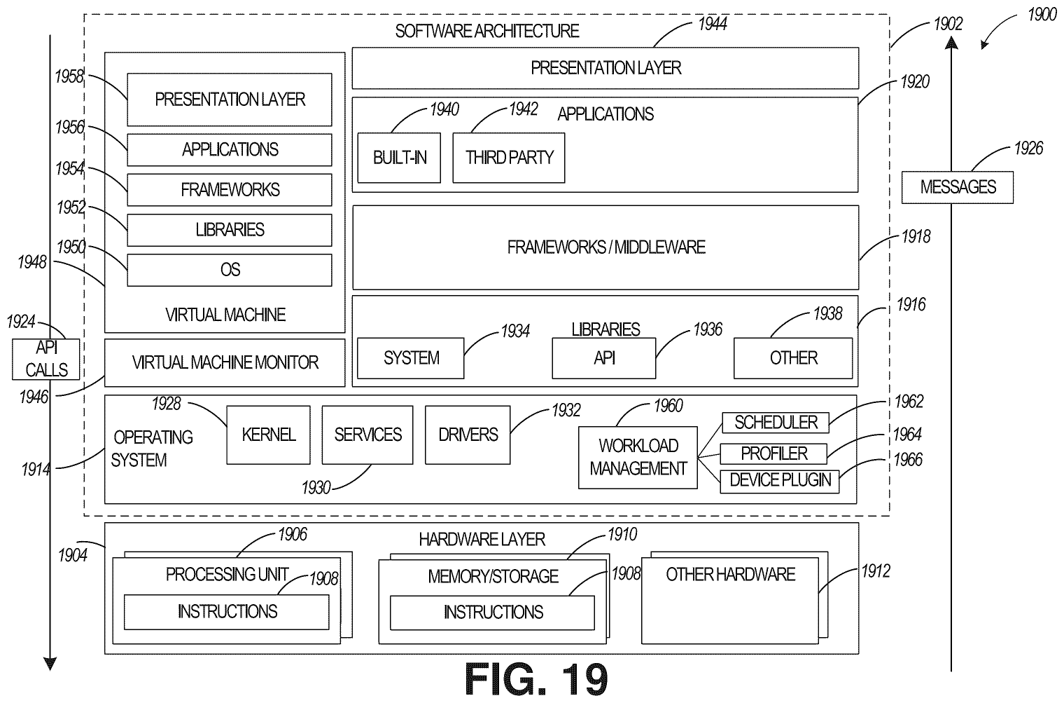

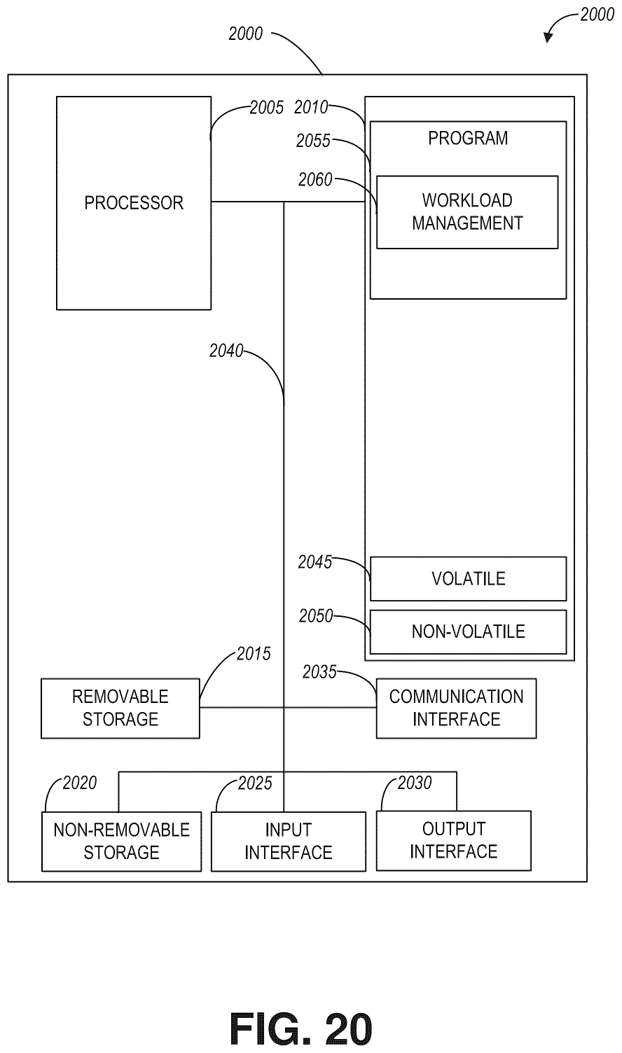

FIG. 18 is a flowchart of method 1800 suitable for workload scheduling, according to some example embodiments. The method 1800 can be a computer-implemented method that includes operations 1802, 1804, 1806, 1808, and 1810. By way of example and not limitation, method 1800 is described as being performed by one or more of the components of the workload management module 115 (also referenced as the workload management module 1960 of FIG. 19 or 2060 of FIG. 20), including a scheduler module, an AI-powered analyzer module with a DL model, a profiler module, and a device plugin.

At operation 1802, execution of a first workload is initiated on a GPU of a plurality of GPUs. For example, the scheduler module 804 schedules the execution of workload 802 on at least one vGPU associated with one of the GPUs 728 of worker node 704.

At operation 1804, utilization metrics of the first workload are determined. For example, profiler module 808 (which can be the same as profiler module 718) determines utilization metrics associated with the dry run execution of workload 802 on the at least one vGPU.

At operation 1806, a useful feature set of the utilization metrics of the first workload is extracted using a transformation function of a DL model. For example, as discussed in connection with FIG. 12-FIG. 16, a transformation function E(m) is determined using the encoder network of the trained DL model 812. The useful feature set F is then extracted using the transformation function and the obtained utilization metrics. In some aspects, the useful feature set is a subset of the utilization metrics.

At operation 1808, a workload type of the first workload is determined using the useful feature set. For example, as discussed in connection with FIG. 14, the workload type can be determined by categorizing the workload into at least one workload type of a prior workload based on a comparison of corresponding useful feature sets.

At operation 1810, a shared execution of the first workload and a second workload is configured on a second GPU of the plurality of GPUs based on packing the first workload with the second workload. The second workload is associated with the determined workload type of the first workload. For example, if the difference between the useful feature set of the first workload and the prior workload is less than a threshold amount, the first workload can be indicated as the same type as the prior workload. The packing table can then be referenced and used for selecting an optimal workload partner for packing and sharing GPU resources. The optimal workload partner can be selected to be of the same type as the first workload and minimize workload interference and JCTs.

FIG. 19 is a block diagram illustrating a representative software architecture 1900, which may be used in conjunction with various device hardware described herein, according to some example embodiments. FIG. 19 is merely a non-limiting example of software architecture 1902, and it will be appreciated that many other architectures may be implemented to facilitate the functionality described herein. The software architecture 1902 may be executed on hardware such as computing device 2000 of FIG. 20, which includes, among other things, processor 2005, memory 2010, storage 2015 and 2020, and I/O components (or interfaces) 2025 and 2030. A representative hardware layer 1904 is illustrated and can represent, for example, the computing device 2000 of FIG. 20. The representative hardware layer 1904 comprises one or more processing units 1906 having associated executable instructions 1908. Executable instructions 1908 represent the executable instructions of the software architecture 1902, including implementation of the methods, modules, and so forth of FIGS. 1-18. Hardware layer 1904 also includes memory and/or storage modules 1910, which also have executable instructions 1908. Hardware layer 1904 may also comprise other hardware 1912, which represents any other hardware of the hardware layer 1904, such as the other hardware illustrated as part of computing device 2000.

In the example architecture of FIG. 19, the software architecture 1902 may be conceptualized as a stack of layers where each layer provides particular functionality. For example, the software architecture 1902 may include layers such as an operating system 1914, libraries 1916, frameworks/middleware 1918, applications 1920, and presentation layer 1944. Operationally, the applications 1920 and/or other components within the layers may invoke application programming interface (API) calls 1924 through the software stack and receive a response, returned values, and so forth illustrated as messages 1926 in response to the API calls 1924. The layers illustrated in FIG. 19 are representative in nature and not all software architectures 1902 have all layers. For example, some mobile or special purpose operating systems may not provide frameworks/middleware 1918, while others may provide such a layer. Other software architectures may include additional or different layers.

The operating system 1914 may manage hardware resources and provide common services. The operating system 1914 may include, for example, a kernel 1928, services 1930, drivers 1932, and a workload management module 1960. The workload management module 1960 can include a scheduler module 1962 (with an AI-powered analyzer module with a DL model), a profiler module 1964, and a device plugin 1966. The kernel 1928 may act as an abstraction layer between the hardware and the other software layers. For example, kernel 1928 may be responsible for memory management, processor management (e.g., scheduling), component management, networking, security settings, and so on. The services 1930 may provide other common services for the other software layers. The drivers 1932 may be responsible for controlling or interfacing with the underlying hardware. For instance, the drivers 1932 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

In some aspects, the workload management module 1960, scheduler module 1962, the profiler module 1964, and the device plugin 1966 can be the same as (and perform the same functionalities as) corresponding similarly-named modules discussed in connection with FIG. 1-FIG. 18.

The libraries 1916 may provide a common infrastructure that may be utilized by the applications 1920 and/or other components and/or layers. The libraries 1916 typically provide functionality that allows other software modules to perform tasks more efficiently than to interface directly with the underlying operating system 1914 functionality (e.g., kernel 1928, services 1930, drivers 1932, and/or modules 1960-1966). The libraries 1916 may include system libraries 1934 (e.g., C standard library) that may provide functions such as memory allocation functions, string manipulation functions, mathematic functions, and the like. In addition, the libraries 1916 may include API libraries 1936 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1916 may also include a wide variety of other libraries 1938 to provide many other APIs to the applications 1920 and other software components/modules.

The frameworks/middleware 1918 (also sometimes referred to as middleware) may provide a higher-level common infrastructure that may be utilized by the applications 1920 and/or other software components/modules. For example, the frameworks/middleware 1918 may provide various graphical user interface (GUI) functions, high-level resource management, high-level location services, and so forth. The frameworks/middleware 1918 may provide a broad spectrum of other APIs that may be utilized by the applications 1920 and/or other software components/modules, some of which may be specific to a particular operating system 1914 or platform.

The applications 1920 include built-in applications 1940 and/or third-party applications 1942. Examples of representative built-in applications 1940 may include but are not limited to, a contacts application, a browser application, a book reader application, a location application, a media application, a messaging application, and/or a game application. Third-party applications 1942 may include any of the built-in applications 1940 as well as a broad assortment of other applications. In a specific example, the third-party application 1942 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 1942 may invoke the API calls 1924 provided by the mobile operating system such as operating system 1914 to facilitate functionality described herein.

The applications 1920 may utilize built-in operating system functions (e.g., kernel 1928, services 1930, drivers 1932, and/or modules 1960-1964), libraries (e.g., system libraries 1934, API libraries 1936, and other libraries 1938), and frameworks/middleware 1918 to create user interfaces to interact with users of the system. Alternatively, or additionally, in some systems, interactions with a user may occur through a presentation layer, such as presentation layer 1944. In these systems, the application/module “logic” can be separated from the aspects of the application/module that interact with a user.

Some software architectures utilize virtual machines. In the example of FIG. 19, this is illustrated by the virtual machine 1948. A virtual machine creates a software environment where applications/modules can execute as if they were executing on a hardware machine (such as the computing device 2000 of FIG. 20, for example). A virtual machine 1948 is hosted by a host operating system (operating system 1914 in FIG. 19) and typically, although not always, has a virtual machine monitor 1946, which manages the operation of the virtual machine 1948 as well as the interface with the host operating system (i.e., operating system 1914). Software architecture 1902 executes within the virtual machine 1948, such as an operating system 1950, libraries 1952, frameworks/middleware 1954, applications 1956, and/or presentation layer 1958. These layers of software architecture executing within the virtual machine 1948 can be the same as the corresponding layers previously described or may be different.

FIG. 20 is a block diagram illustrating circuitry for a device that implements algorithms and performs methods, according to some example embodiments. Not all components need to be used in various embodiments. For example, clients, servers, and cloud-based network devices may each use a different set of components or, in the case of servers, larger storage devices.

One example computing device in the form of a computer (also referred to as computing device 2000, computer system 2000, or computer 2000) may include a processor 2005, memory 2010, removable storage 2015, non-removable storage 2020, input interface 2025, output interface 2030, and communication interface 2035, all connected by a bus 2040. Although the example computing device is illustrated and described as the computer 2000, the computing device may be in different forms in different embodiments.

Memory 2010 may include volatile memory 2045 and non-volatile memory 2050 and may store a program 2055. The computer 2000 may include—or have access to a computing environment that includes—a variety of computer-readable media, such as the volatile memory 2045, the non-volatile memory 2050, the removable storage 2015, and the non-removable storage 2020. Computer storage includes random-access memory (RAM), read-only memory (ROM), erasable programmable read-only memory (EPROM) and electrically erasable programmable read-only memory (EEPROM), flash memory or other memory technologies, compact disc read-only memory (CD ROM), digital versatile disks (DVD) or other optical disk storage, magnetic cassettes, magnetic tape, magnetic disk storage or other magnetic storage devices, or any other medium capable of storing computer-readable instructions.

Computer-readable instructions stored on a computer-readable medium (e.g., the program 2055 stored in the memory 2010) are executable by the processor 2005 of the computer 2000. A hard drive, CD-ROM, and RAM are some examples of articles that include a non-transitory computer-readable medium such as a storage device. The terms “computer-readable medium” and “storage device” do not include carrier waves to the extent that carrier waves are deemed too transitory. “Computer-readable non-transitory media” includes all types of computer-readable media, including magnetic storage media, optical storage media, flash media, and solid-state storage media. It should be understood that software can be installed on and sold with a computer. Alternatively, the software can be obtained and loaded into the computer, including obtaining the software through a physical medium or distribution system, including, for example, from a server owned by the software creator or from a server not owned but used by the software creator. The software can be stored on a server for distribution over the Internet, for example. As used herein, the terms “computer-readable medium” and “machine-readable medium” are interchangeable.

The program 2055 may utilize modules discussed herein, such as a workload management module 2060, which can be the same as (and perform the same functionalities as) workload management modules discussed in connection with FIG. 1-FIG. 19.

Any one or more of the modules described herein may be implemented using hardware (e.g., a processor of a machine, an application-specific integrated circuit (ASIC), field-programmable gate array (FPGA), or any suitable combination thereof). Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In some aspects, one or more of the modules included in the workload management module 2060 can be integrated as a single module, performing the corresponding functions of the integrated modules.

Although a few embodiments have been described in detail above, other modifications are possible. For example, the logic flows depicted in the figures do not require the particular order shown, or sequential order, to achieve desirable results. Other steps may be provided, or steps may be eliminated from the described flows, and other components may be added to or removed from the described systems. Other embodiments may be within the scope of the following claims.

It should be further understood that software, including one or more computer-executable instructions that facilitate processing and operations as described above concerning any one or all of the steps of the disclosure, can be installed and sold with one or more computing devices consistent with the disclosure. Alternatively, the software can be obtained and loaded into one or more computing devices, including obtaining software through a physical medium or distribution system, including, for example, from a server owned by the software creator or from a server not owned but used by the software creator. The software can be stored on a server for distribution over the Internet, for example.

Also, it will be understood by one skilled in the art that this disclosure is not limited in its application to the details of construction and the arrangement of components outlined in the description or illustrated in the drawings. The embodiments herein are capable of other embodiments and capable of being practiced or carried out in various ways. Also, it will be understood that the phraseology and terminology used herein are for description and should not be regarded as limiting. The use of “including,” “comprising,” or “having” and variations thereof herein is meant to encompass the items listed thereafter and equivalents thereof, as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Further, terms such as up, down, bottom, and top are relative and are employed to aid illustration but are not limiting.

The components of the illustrative devices, systems, and methods employed in accordance with the illustrated embodiments can be implemented, at least in part, in digital electronic circuitry, analog electronic circuitry, or computer hardware, firmware, software, or combinations of them. These components can be implemented, for example, as a computer program product such as a computer program, program code, or computer instructions tangibly embodied in an information carrier or a machine-readable storage device, for execution by, or to control the operation of, data processing apparatus such as a programmable processor, a computer, or multiple computers.

A computer program can be written in any form of programming language, including compiled or interpreted languages, and it can be deployed in any form, including as a stand-alone program or as a module, component, subroutine, or another unit suitable for use in a computing environment. A computer program can be deployed to be executed on one computer or multiple computers at one site or distributed across multiple sites and interconnected by a communication network. Also, functional programs, codes, and code segments for accomplishing the techniques described herein can be easily construed as within the scope of the claims by programmers skilled in the art to which the techniques described herein pertain. Method steps associated with the illustrative embodiments can be performed by one or more programmable processors executing a computer program, code, or instructions to perform functions (e.g., by operating on input data and/or generating an output). Method steps can also be performed, and the apparatus for performing the methods can be implemented as special-purpose logic circuitry, e.g., an FPGA (field programmable gate array) or an ASIC (application-specific integrated circuit), for example.

The various illustrative logical blocks, modules, and circuits described in connection with the embodiments disclosed herein may be implemented or performed with a general-purpose processor, a digital signal processor (DSP), an ASIC, an FPGA, or other programmable logic devices, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors and any one or more processors of any digital computer. Generally, a processor will receive instructions and data from a read-only memory, a random-access memory, or both. The required elements of a computer are a processor for executing instructions and one or more memory devices for storing instructions and data. Generally, a computer will also include or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by or incorporated into special-purpose logic circuitry.

Those with skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

As used herein, “machine-readable medium” (or “computer-readable medium”) means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database or associated caches and servers) able to store processor instructions. The term “machine-readable medium” shall also be taken to include any medium (or a combination of multiple media) that is capable of storing instructions for execution by one or more processors 2005, such that the instructions, when executed by one or more processors 2005, cause the one or more processors 2005 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium,” as used herein, excludes signals per se.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the scope disclosed herein.

Although the present disclosure has been described concerning specific features and embodiments thereof, it is evident that various modifications and combinations can be made thereto without departing from the scope of the disclosure. For example, other components may be added to or removed from the described systems. The specification and drawings are, accordingly, to be regarded simply as an illustration of the disclosure as defined by the appended claims and are contemplated to cover any modifications, variations, combinations, or equivalents that fall within the scope of the present disclosure. Other aspects may be within the scope of the following claims.

What is claimed is:

1. A computer-implemented method for artificial intelligence (AI)-based scheduling of workloads, the method comprising:
initiating execution of a first workload on a graphics processing unit (GPU) of a plurality of GPUs;
determining utilization metrics of the first workload, the utilization metrics associated with the execution of the first workload on the GPU;
extracting a useful feature set of the utilization metrics of the first workload using a transformation function of a deep learning (DL) model, the useful feature set including a subset of the utilization metrics;
determining a workload type of the first workload using the useful feature set; and
configuring a shared execution of the first workload and a second workload on a second GPU of the plurality of GPUs based on packing the first workload with the second workload, the second workload associated with the workload type of the first workload.

2. The computer-implemented method of claim 1, wherein the DL model includes an AI-based encoder and an AI-based decoder, and the method further comprises:
performing training of the DL model using a first set of training data as an input to the AI-based encoder and a second set of training data as an output of the AI-based decoder.

3. The computer-implemented method of claim 2, further comprising:
configuring the first set of training data to include prior utilization metrics for a plurality of workloads executed before the execution of the first workload, the plurality of workloads including the second workload.

4. The computer-implemented method of claim 3, further comprising:
configuring the second set of training data as a plurality of joint completion times associated with a corresponding plurality of joint executions associated with the plurality of workloads.

5. The computer-implemented method of claim 4, wherein a joint execution of the corresponding plurality of joint executions includes at least two of the plurality of workloads executing on a same GPU of the plurality of GPUs.

6. The computer-implemented method of claim 1, further comprising:
determining the transformation function using a subset of convolution layers of a plurality of convolution layers on an AI-based encoder of the DL model.

7. The computer-implemented method of claim 6, further comprising:
applying the transformation function to utilization metrics of a plurality of workloads to obtain additional useful feature sets, the plurality of workloads executed before the execution of the first workload, and the plurality of workloads including the second workload.

8. The computer-implemented method of claim 7, further comprising:
determining the workload type of the first workload using a comparison of the useful feature set with each of the additional useful feature sets; and
selecting the second workload based on the comparison.

9. The computer-implemented method of claim 8, wherein the selecting of the second workload comprises:
selecting the second workload when the useful feature set is different from an additional useful feature set of the additional useful feature sets by at most a threshold value, the additional useful feature set associated with the second workload.

10. The computer-implemented method of claim 9, further comprising:
performing the configuring of the shared execution of the first workload and the second workload, when the useful feature set is different from the additional useful feature set by not more than the threshold value.

11. The computer-implemented method of claim 1 further comprising:
configuring a plurality of virtual GPUs (vGPUs) of the second GPU; and
configuring the shared execution of the first workload and the second workload using the plurality of vGPUs of the second GPU.

12. The computer-implemented method of claim 1, wherein the utilization metrics comprise at least one of:
a histogram of GPU usage by one or more containers associated with the execution of the first workload;
a histogram of memory usage of a computing node associated with the execution of the first workload; and
a GPU type associated with the GPU used for the execution of the first workload.

13. A system for artificial intelligence (AI)-based scheduling of workloads, the system comprising:
a memory storing instructions; and
at least one processor in communication with the memory, the at least one processor configured, upon execution of the instructions, to perform operations comprising:
initiating execution of a first workload on a graphics processing unit (GPU) of a plurality of GPUs;
determining utilization metrics of the first workload, the utilization metrics associated with the execution of the first workload on the GPU;
extracting a useful feature set of the utilization metrics of the first workload using a transformation function of a deep learning (DL) model, the useful feature set including a subset of the utilization metrics;
determining a workload type of the first workload using the useful feature set; and
configuring a shared execution of the first workload and a second workload on a second GPU of the plurality of GPUs based on packing the first workload with the second workload, the second workload associated with the workload type of the first workload.

14. The system of claim 13, wherein the DL model includes an AI-based encoder and an AI-based decoder, and the operations further comprise:
performing training of the DL model using a first set of training data as an input to the AI-based encoder and a second set of training data as an output of the AI-based decoder;
configuring the first set of training data to include prior utilization metrics for a plurality of workloads executed before the execution of the first workload, the plurality of workloads including the second workload; and
configuring the second set of training data as a plurality of joint completion times associated with a corresponding plurality of joint executions associated with the plurality of workloads.

15. The system of claim 14, wherein a joint execution of the corresponding plurality of joint executions includes at least two of the plurality of workloads executing on a same GPU of the plurality of GPUs, and wherein the operations further comprise:
determining the transformation function using a subset of convolution layers of a plurality of convolution layers on an AI-based encoder of the DL model;
applying the transformation function to utilization metrics of a plurality of workloads to obtain additional useful feature sets, the plurality of workloads executed before the execution of the first workload, and the plurality of workloads including the second workload;
determining the workload type of the first workload using a comparison of the useful feature set with each of the additional useful feature sets; and
selecting the second workload based on the comparison.

16. A non-transitory computer-readable medium storing computer instructions for artificial intelligence (AI)-based scheduling of workloads, wherein the instructions when executed by one or more processors, cause the one or more processors to perform operations comprising:
initiating execution of a first workload on a graphics processing unit (GPU) of a plurality of GPUs;
determining utilization metrics of the first workload, the utilization metrics associated with the execution of the first workload on the GPU;
extracting a useful feature set of the utilization metrics of the first workload using a transformation function of a deep learning (DL) model, the useful feature set including a subset of the utilization metrics;
determining a workload type of the first workload using the useful feature set; and
configuring a shared execution of the first workload and a second workload on a second GPU of the plurality of GPUs based on packing the first workload with the second workload, the second workload associated with the workload type of the first workload.

17. The non-transitory computer-readable medium of claim 16, wherein the DL model includes an AI-based encoder and AI-based decoder, and the operations further comprising:
performing training of the DL model using a first set of training data as an input to the AI-based encoder and a second set of training data as an output of the AI-based decoder;
configuring the first set of training data to include prior utilization metrics for a plurality of workloads executed before the execution of the first workload, the plurality of workloads including the second workload; and
configuring the second set of training data as a plurality of joint completion times associated with a corresponding plurality of joint executions associated with the plurality of workloads,
wherein a joint execution of the plurality of joint executions includes at least two of the plurality of workloads executing on a same GPU of the plurality of GPUs.

18. The non-transitory computer-readable medium of claim 16, the operations further comprising:
determining the transformation function using a subset of convolution layers of a plurality of convolution layers on an AI-based encoder of the DL model.

19. The non-transitory computer-readable medium of claim 18, the operations further comprising:
applying the transformation function to utilization metrics of a plurality of workloads to obtain additional useful feature sets, the plurality of workloads executed before the execution of the first workload, and the plurality of workloads including the second workload;
determining the workload type of the first workload using a comparison of the useful feature set with each of the additional useful feature sets; and
selecting the second workload based on the comparison.

20. The non-transitory computer-readable medium of claim 19, wherein the operations for the selecting of the second workload comprise:
selecting the second workload when the useful feature set is different from an additional useful feature set of the additional useful feature sets by at most a threshold value, the additional useful feature set associated with the second workload.
